(19) United States
(12) Patent Application Publication
(10) Pub. No.: US 2024/0362559 A1
(43) Pub. Date: Oct. 31, 2024

(54) Enhancing Software Extensibility For Cloud Environments

(71) Applicant: Oracle International Corporation, Redwood Shores, CA (US)

(72) Inventors: Somnath Lahiri, Seattle, WA (US); Benjamin Roux, Seattle, WA (US)

(73) Assignee: Oracle International Corporation, Redwood Shores, CA (US)

(21) Appl. No.: 18/643,464

(22) Filed: Apr. 23, 2024

Related U.S. Application Data
(60) Provisional application No. 63/462,885, filed on Apr. 28, 2023.

(51) Int. Cl. G06Q 10/0631

(52) U.S. Cl. CPC G06Q 10/06315

(57) ABSTRACT

Techniques for enhancing software extensibility in cloud environments are disclosed. One or more embodiments receive instructions to define services and workers within the cloud, categorize workers based on predefined types, apply corresponding predefined functionality, and instantiate corresponding cloud-based infrastructure. Additionally, one or more embodiments facilitate communication and integration with third-party services. One or more embodiments further generate canary components to help ensure service operationality. An approval processes may be used to certify compliance with cloud standards. Such techniques enhance cloud service deployment, scalability, and interoperability while maintaining security and reliability.

### INCORPORATION BY REFERENCE; DISCLAIMER

Each of the following applications are hereby incorporated by reference: Application No. 63/462,885 filed on Apr. 28, 2023. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to software development for cloud environments. In particular, the present disclosure relates to enhancing software extensibility in cloud environments.

### BACKGROUND

A cloud computing environment can be used to provide access to a range of complementary cloud-based components, such as software applications or services, that allow organizations or enterprise customers to operate their applications and services in a highly available hosted environment. The benefits to an organization in moving their application and service needs to a cloud environment include a reduction in the cost and complexity of designing, building, operating, and maintaining their own on-premise data center, software application framework, or other information technology infrastructure.

Cloud service providers (CSPs) distinguish between first-party services and second- or third-party services. First-party services are provided by the CSP itself as native features of the cloud environment, benefit from the built-in security measures of the cloud environment, and integrate with the cloud infrastructure. In contrast, second- and third-party services are typically provided by entities other than the CSP. Second- or third-party services are often bespoke products that are not distributed outside of the specific tenancy for which they were developed. Thus, different tenants may replicate the time and other resources to develop services that are functionally very similar.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for providing a cloud infrastructure environment in accordance with an embodiment.

FIG. 2 further illustrates how a cloud infrastructure environment can be used to provide cloud-based applications or services or services in accordance with an embodiment.

FIG. 3 illustrates an example cloud infrastructure architecture in accordance with an embodiment.

FIG. 4 illustrates another example of a cloud infrastructure architecture in accordance with an embodiment.

FIG. 5 illustrates another example of a cloud infrastructure architecture in accordance with an embodiment.

FIG. 6 illustrates another example of a cloud infrastructure architecture in accordance with an embodiment.

FIG. 7 illustrates how the system can provide dedicated or private label cloud environments for use by tenants or customers of a cloud infrastructure environment in accordance with an embodiment.

FIG. 8 further illustrates the use of private label cloud realms for use by tenants or customers of a cloud infrastructure environment in accordance with an embodiment.

FIG. 9 further illustrates the use of private label cloud realms for use by tenants or customers of a cloud infrastructure environment in accordance with an embodiment.

FIG. 10 illustrates a system for providing access to software products or services in a cloud computing or other computing environment in accordance with an embodiment.

FIG. 11 illustrates a system for configuring and deploying services in a cloud environment, in accordance with one or more embodiments.

FIG. 12A illustrates an example set of operations for providing software extensibility in cloud environments, in accordance with one or more embodiments.

FIG. 12B illustrates an example set of operations for providing software extensibility in cloud environments, in accordance with one or more embodiments.

FIG. 13 illustrates an example embodiment for configuring worker interactions within a service and between services in a cloud environment, in accordance with an embodiment.

FIG. 14 of the invention illustrates an example system and method for implementing a cloud-based notifications service, in accordance with an embodiment.

FIG. 15 illustrates an example system and method for implementing a cloud-based connector hub service, in accordance with an embodiment.

FIG. 16 illustrates an example of a code snippet used for configuring a canary component to test a service within a cloud environment, in accordance with an embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

1. GENERAL OVERVIEW

2. DEDICATED OR PRIVATE LABEL CLOUD ENVIRONMENTS

3. ACCESS CONTROL ARCHITECTURE

4. CONTROLLING ACCESS TO CLOUD RESOURCES

5. EXAMPLE EMBODIMENT: WORKERS AND WORKER TYPES

6. EXAMPLE EMBODIMENT FOR A NOTIFICATIONS SERVICE

7. EXAMPLE EMBODIMENT FOR A CONNECTOR HUB SERVICE

8. MISCELLANEOUS; EXTENSIONS

### 1. General Overview

One or more embodiments provide software extensibility in cloud environments by generating services based on user-provided definitions of workers, which are predefined, configurable service components. Specifically, one or more embodiments receive instructions to define services and workers within the cloud, categorize workers based on predefined types, apply corresponding predefined functionality, and instantiate corresponding cloud-based infrastructure. Additionally, one or more embodiments facilitate communication and integration with third-party services. One or more embodiments further generate canary components, which test service operationality and raise alarms in the event that a service does not satisfy minimum requirements for operationality. One or more embodiments further include an approval process for certifying compliance with threshold cloud service standards. A CSP may deploy a service that complies with those standards in the same manner as a first-party service, so that such services can be reused by different entities (e.g., tenants) in the cloud environment. Approaches described herein help to optimize cloud service deployment, scalability, and interoperability while maintaining security and reliability.

One or more embodiments described in this Specification and/or recited in the claims may not be included in this General Overview section.

### 2. Example Cloud Environments

One or more embodiments provide features associated with cloud environments, including dedicated or private label cloud (PLC) environments. The cloud environments can be utilized, for example, by customers or tenants of a cloud infrastructure provider or reseller, in accessing software products, services, or other cloud offerings.

A cloud computing or cloud infrastructure environment can be used to provide access to a range of complementary cloud-based components, such as software applications or services, that allow organizations or enterprise customers to operate their applications and services in a highly available hosted environment.

The benefits to an organization in moving their application and service needs to a cloud infrastructure environment include a reduction in the cost and complexity of designing, building, operating, and maintaining their own on-premise data center, software application framework, or other information technology infrastructure.

### Cloud Infrastructure Environments

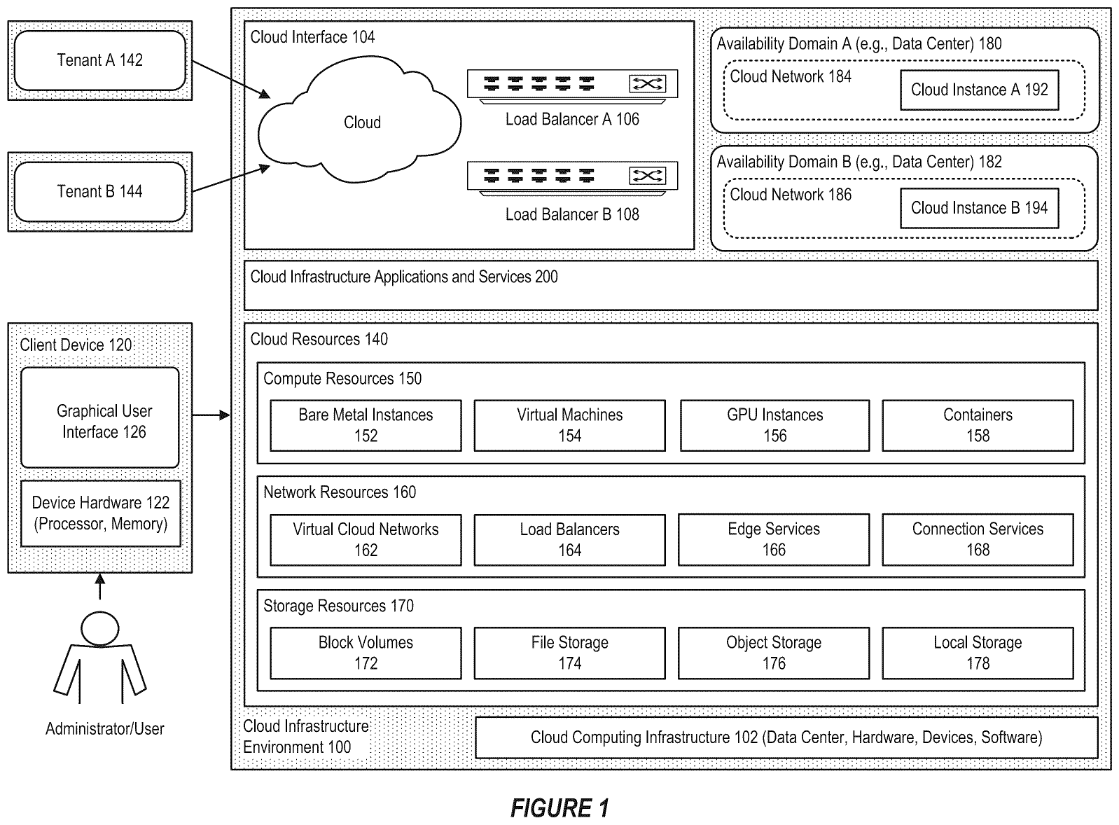

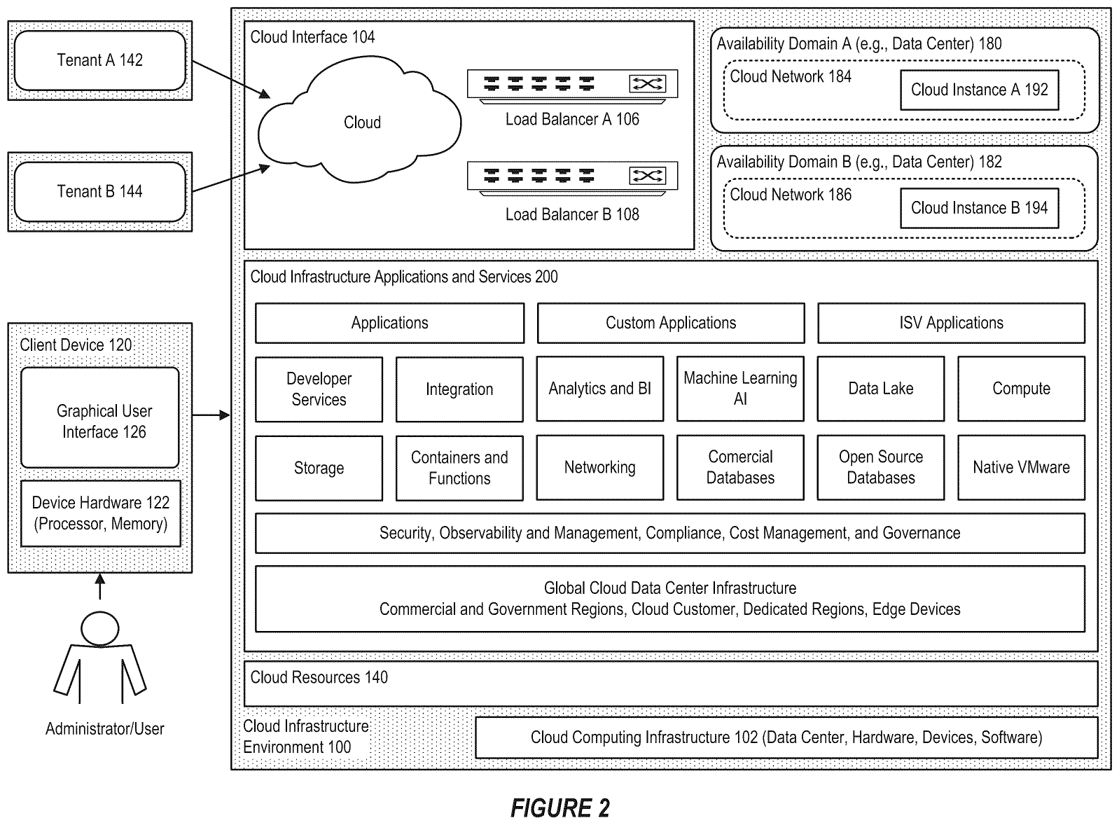

FIGS. 1 and 2 illustrate a system for providing a cloud infrastructure environment, in accordance with an embodiment.

In accordance with an embodiment, the components and processes illustrated in FIG. 1, and as further described herein regarding various embodiments, can be provided as software or program code executable by a computer system or other type of processing device, for example, a cloud computing system.

The illustrated example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (APIs) that provide access to the shared cloud resources via one or more load balancers A 106, B 108. Cloud interface 102 includes user interfaces and APIs provided by a cloud services provider for interacting with its cloud services. This includes tools and platforms that allow users and administrators to manage, configure, and monitor cloud resources and services. Cloud interface 102 may include a console, such as a web-based user interface that provides a visual way to interact with and manage cloud resources. Through the console, users may, for example, create, configure, and monitor cloud services like compute instances, databases, storage, and networking components. Cloud interface 102 may also include a command line interface for users who prefer to work with the cloud infrastructure using command-line tools. The CLI allows for scripting and automation of cloud management tasks in an embodiment.

In accordance with an embodiment, load balancer A 106 and load balancer B 108 are services that distribute incoming network traffic across multiple servers, instances, or other resources to ensure that no single resource bears too much demand. By spreading the requests evenly across the resources, load balancers enhance the responsiveness and availability of resources such as applications, websites, or databases. Load balancer A 106 and load balancer B 108 may be either public load balancers that are accessible from the Internet and used for distributing external traffic, or private load balancers that are used within a virtual cloud network (VCN) and are not accessible from the public Internet (and are therefore ideal for internal traffic distribution). In an embodiment, load balancer A 106 and load balancer B 108 are designed for high availability and fault tolerance and are implemented in a redundant configuration across multiple availability domains or fault domains.

In accordance with an embodiment, the cloud infrastructure environment supports the use of availability domains, such as availability domain A 180 and availability domain B 182, that allow customers to create and access cloud networks 184, 186, and run cloud instances A 192, B 194. In an embodiment, availability A 180 and availability domain B 182 may represent a data center, or a set of data centers located within a region. These availability domains may be isolated from each other, meaning that they may not share the same physical infrastructure such as power or cooling systems. This design provides a high degree of failure independence and robustness. In an embodiment, a fault domain may provide additional protection and resiliency within a single availability domain by grouping hardware and infrastructure within an availability domain that is isolated from other fault domains. This isolation may be in terms of electricity, cooling, and other potential sources of failure.

In accordance with an embodiment, a tenancy (a container for resources used by a tenant) can be created for each cloud tenant/customer, for example, tenant A 142, B 144, that provides a secure and isolated partition within the cloud infrastructure environment where the customer can create, organize, and administer their cloud resources. A cloud tenant/customer can access an availability domain and a cloud network to access each of their cloud instances. A tenancy in is isolated from other tenancies, ensuring that each customer's data and resources are secure and inaccessible to others. Within a tenancy, customers can create, manage, and organize a wide range of cloud resources, including compute instances, storage volumes, and networks. In Identity and Access Management (IAM) service allows the management of users, groups, and policies within a tenancy. Through IAM, customers can control who has access to their resources and what actions they can perform. The tenancy is also the level where billing and subscription management are handled. Usage and costs associated with the resources within a tenancy are tracked and billed collectively under that tenancy. Each tenancy may be associated with specific service limits and quotas for various resources. These limits may be used to help manage capacity and facilitate resource distribution across each tenant.

In accordance with an embodiment, a computing device, such as a client device 120 having a device hardware 122 (e.g., processor, memory) and graphical user interface 126, can allow an administrator or other user to communicate with the cloud infrastructure environment via a network, such as a wide area network, a local area network, or the Internet, to create or update cloud services.

In accordance with an embodiment, the cloud infrastructure environment provides access to shared cloud resources 140 via, for example, a compute resources layer 150, a network resources layer 160, and/or a storage resources layer 170. Customers can launch cloud instances as needed to meet compute and application requirements. After a customer provisions and launches a cloud instance, the provisioned cloud instance can be accessed from a client device such as client device 120.

In accordance with an embodiment, compute resources 150 can comprise resources, such as bare metal cloud instances 152, virtual machines 154, graphical processing unit (GPU) compute cloud instances 156, and/or containers 158. A bare metal instance represents a physical server with dedicated hardware that is fully allocated to a single tenant. A bare metal instance provides direct access to the server's processor, memory, storage, and other hardware resources. A virtual machine (VM) is a software emulation of a physical computer that runs an operating system and applications like a physical computer. VMs allow multiple operating systems to run on a single physical machine or across multiple machines. A hypervisor layer resides between the hardware and the virtual machines, allocating physical resources (like CPU, memory, and storage) to each VM. In an embodiment, GPU compute cloud instances provide GPUs along with traditional CPU resources. These instances are designed for tasks that require significant parallel processing power, making them ideal for applications like machine learning, scientific computing, 3D rendering, and video processing. In an embodiment, Containers 158 use a method of virtualization that allows for the running of multiple isolated applications on a single control host, virtualizing the operating system. Each container shares the host system's kernel but runs in an isolated user space, making containers lightweight and efficient.

The components of the compute resources 150 can be used to provision and manage bare metal compute cloud instances or provision cloud instances as needed to deploy and run applications, as in an on-premises data center. For example, in accordance with an embodiment, the cloud infrastructure environment can provide control of physical host (bare metal) machines within the compute resources layer that run as compute cloud instances directly on bare metal servers without a hypervisor.

In accordance with an embodiment, the cloud infrastructure environment can also provide control of virtual machines within the compute resources layer that can be launched, for example, from an image, wherein the types and quantities of resources available to a virtual machine cloud instance can be determined, for example, based upon the image that the virtual machine was launched from.

In accordance with an embodiment, the network resources layer can comprise several network-related resources, such as virtual cloud networks (VCNs) 162, load balancers 164, edge services 166, and/or connection services 168. In an embodiment, a virtual cloud network (VCN) is a customizable and private network in a cloud environment. A VCN provides a virtual version of a traditional network, including subnets, route tables, and gateways. It allows users to set up their cloud-based network architecture according to their requirements. In an embodiment, edge services 166 include services and technologies designed to bring computation, data storage, and networking capabilities closer to the location where they are needed. Edge services 166 may be used to optimize traffic, reduce latency, or provide other advantages.

In accordance with an embodiment, the storage resources layer can comprise several resources, such as data/block volumes 172, file storage 174, object storage 176, and/or local storage 178. Data/block volumes 172 provide unformatted block-level storage that can be used to create file systems that host databases or for other purposes requiring unformatted storage. File storage 174 provides a file system in an embodiment and may offer shared file systems that multiple instances can access concurrently using standard file storage protocols. Object storage 176 manages data as objects within storage buckets. Objects have certain attributes that may include data, metadata, and a unique identifier. Local storage 178 refers to storage devices that are physically attached to the host computer.

As illustrated in FIG. 2, in accordance with an embodiment, the cloud infrastructure environment can include a range of complementary cloud-based components, such as cloud infrastructure applications and services 200, that allow organizations or enterprise customers to operate their applications and services in a highly available hosted environment.

In accordance with an embodiment, a self-contained cloud region can be provided as a complete, e.g., Oracle Cloud Infrastructure (OCI), dedicated region within an organization's data center that offers the data center operator the agility, scalability, and economics of an e.g., OCI public cloud, while retaining full control of their data and applications to meet security, regulatory, or data residency requirements.

For example, in accordance with an embodiment, such an environment can include racks physically and logically managed by a cloud infrastructure provider (e.g., Oracle), customer's racks, access for cloud operations personnel for setup and hardware support, customer's data center power and cooling, customer's floor space, an area for customer's data center personnel, and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's (e.g., Oracle's) public cloud regions, for example, ERP, Financials, HCM, and SCM. A customer can lift and shift legacy workloads using the cloud infrastructure provider's services (e.g., bare metal compute, VMs, and GPUs), database services (e.g., Oracle Autonomous Database), or container-based services (e.g., Oracle Container Engine for Kubernetes).

In accordance with an embodiment, a cloud infrastructure environment can operate according to an infrastructure-as-a-service (IaaS) model that allows the environment to provide virtualized computing resources over a public network (e.g., the Internet)

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components; example services include billing software, monitoring software, logging software, load balancing software, or clustering software. Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not, be a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries or daemons). This is often managed by the cloud infrastructure provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like).

In accordance with an embodiment, IaaS provisioning may refer to acquiring computers or virtual hosts for use and installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on others, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to facilitate deployment of infrastructure code across various virtual computing environments. Additionally, the described techniques can facilitate infrastructure management within these environments. In some examples, service teams can write code that is desired to be deployed to one or more, but often many, different production environments (e.g., across various geographic locations). However, in some examples, the infrastructure where the code will be deployed requires provisioning. In some instances, the provisioning can be done manually, a provisioning tool may be utilized to provision the resources, and/or deployment tools may be utilized to deploy the code once the infrastructure is provisioned.

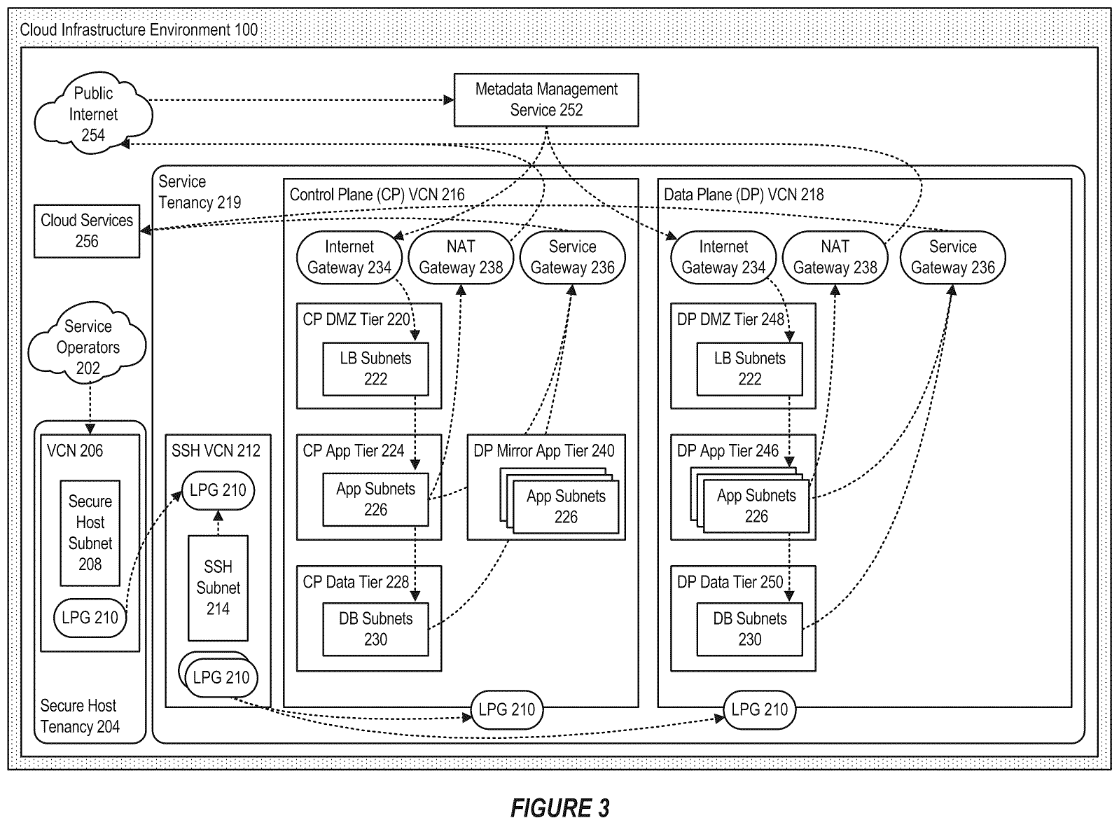

FIG. 3 illustrates an example cloud infrastructure architecture in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices that may be portable handheld devices (e.g., a telephone, a computing tablet, a personal digital assistant (PDA)) or wearable devices (e.g., a head mounted display), running software such as Microsoft Windows, and/or a variety of mobile operating systems, such as iOS, Android, and the like, and being Internet, e-mail, short message service (SMS), or other communication protocol capable. Alternatively, the client computing devices can be general purpose personal computers including, for example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems such as Chrome OS. Additionally, or alternatively, client computing devices may be any other electronic device, such as a thin-client computer, an Internet-capable gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnets 222, a control plane app tier 224 that can include app subnets 226, and a control plane data tier 228 that can include database (DB) subnets 230 (e.g., frontend DB subnet(s) and/or backend DB subnet(s)). The LB subnet(s) contained in the control plane DMZ tier can be communicatively coupled to the app subnet(s) contained in the control plane app tier and to an Internet gateway 234 that can be contained in the control plane VCN. The app subnet(s) can be communicatively coupled to the DB subnet(s) contained in the control plane data tier, a service gateway 236, and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier, a data plane DMZ tier, and a data plane data tier. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make API calls to cloud services without going through the public Internet. The API calls to cloud services from the service gateway can be one-way; the service gateway can make API calls to cloud services, and cloud services can send requested data to the service gateway. Generally, cloud services may not initiate API calls to the service gateway.

In accordance with an embodiment, the secure host tenancy can be directly connected to the service tenancy that may be otherwise isolated. The secure host subnet can communicate with the SSH subnet through an LPG that may facilitate two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example, create, read, update, or delete (CRUD) operations through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both that may be contained in the service tenancy. This embodiment can facilitate isolation of networks that may prevent users or customers from interacting with the resources of other users or other customers. Also, this embodiment may allow users or customers of the system to store databases privately without needing to rely on the public Internet for storage that may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy that may be isolated from the public Internet.

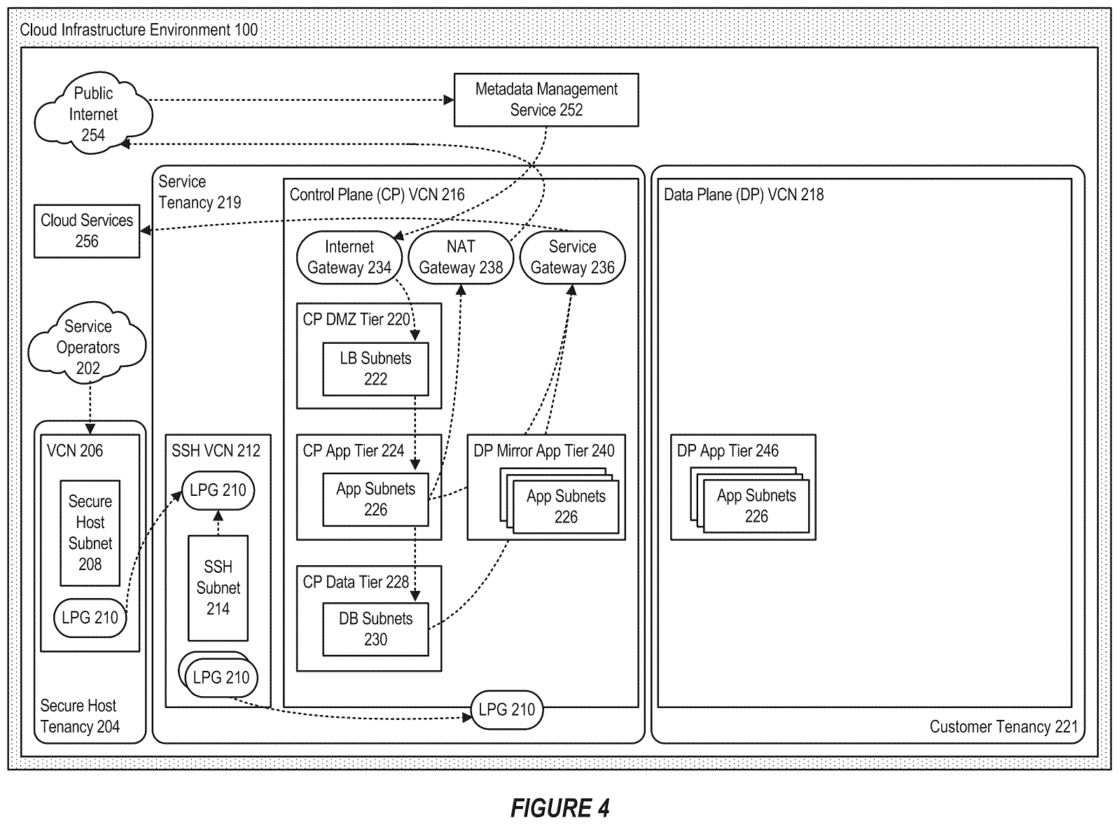

FIG. 4 illustrates another example of a cloud infrastructure architecture in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources provisioned in the control plane VCN contained in the service tenancy to be deployed or otherwise used in the data plane VCN contained in the customer tenancy.

In accordance with an embodiment, a customer of the cloud infrastructure provider may have databases that are managed and operated within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but the data plane mirror app tier may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, by the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with, Deployment 1 in Region 2.

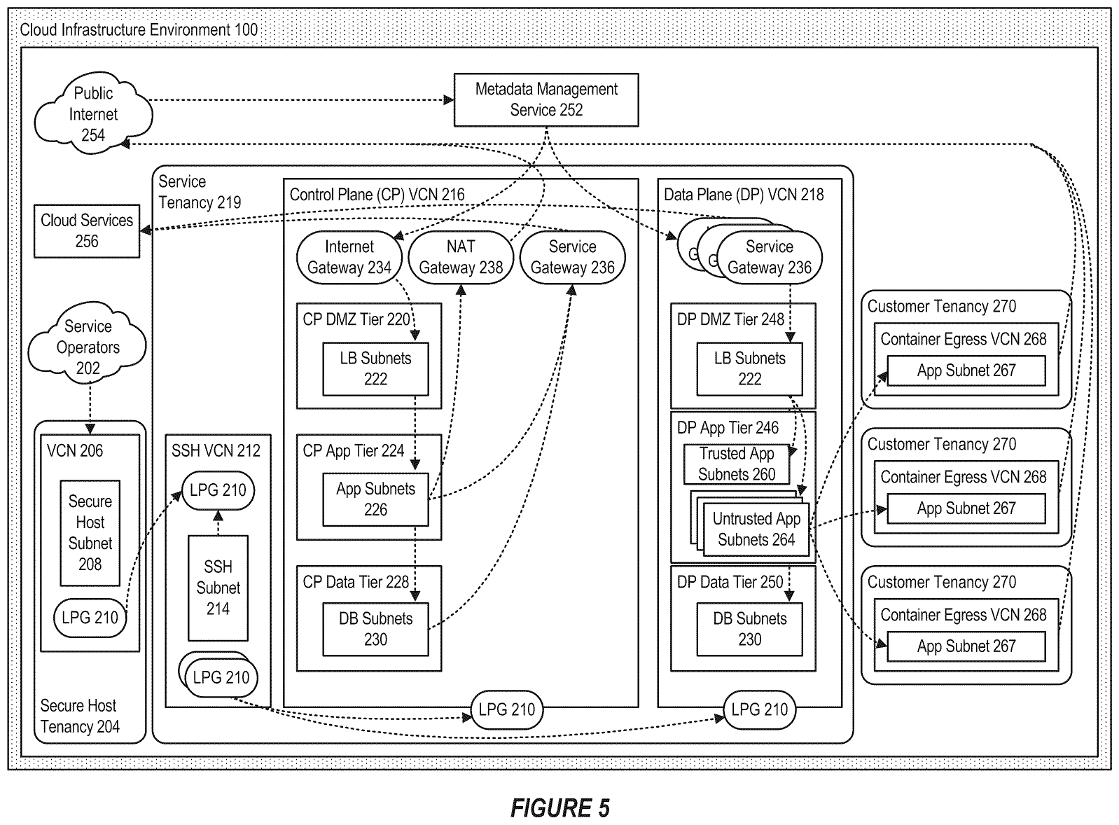

FIG. 5 illustrates another example of a cloud infrastructure architecture in accordance with an embodiment.

As illustrated in FIG. 5, in accordance with an embodiment, the trusted app subnets 260 can be communicatively coupled to the service gateway contained in the data plane VCN, the NAT gateway contained in the data plane VCN, and DB subnet(s) contained in the data plane data tier. The untrusted app subnets 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)) that may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s) and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled, or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

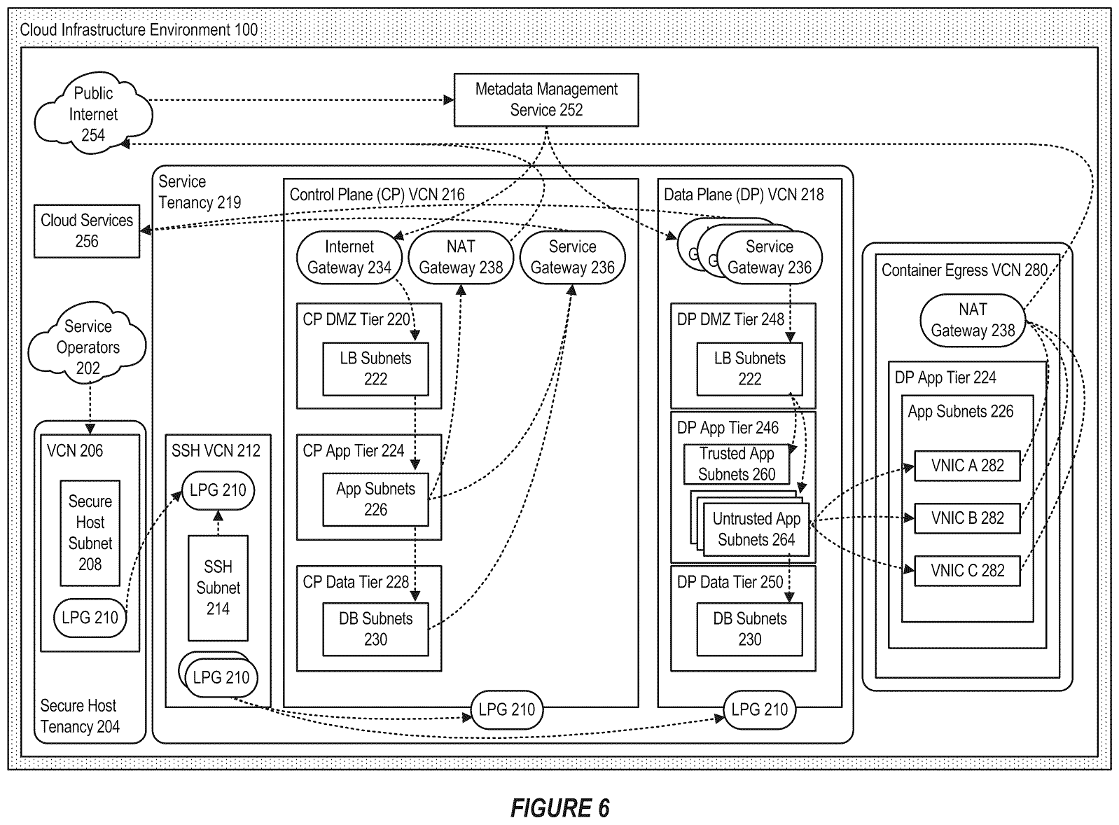

FIG. 6 illustrates another example of a cloud infrastructure architecture in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container and be communicatively coupled to an app subnet that can be contained in a data plane app tier that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that request a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining that the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Private Label Cloud Environments

In accordance with an embodiment, a cloud infrastructure environment can be used to provide dedicated cloud environments, for example, as one or more private label cloud environments for use by tenants of the cloud infrastructure environment in accessing subscription-based software products, services, or other offerings associated with the cloud infrastructure environment.

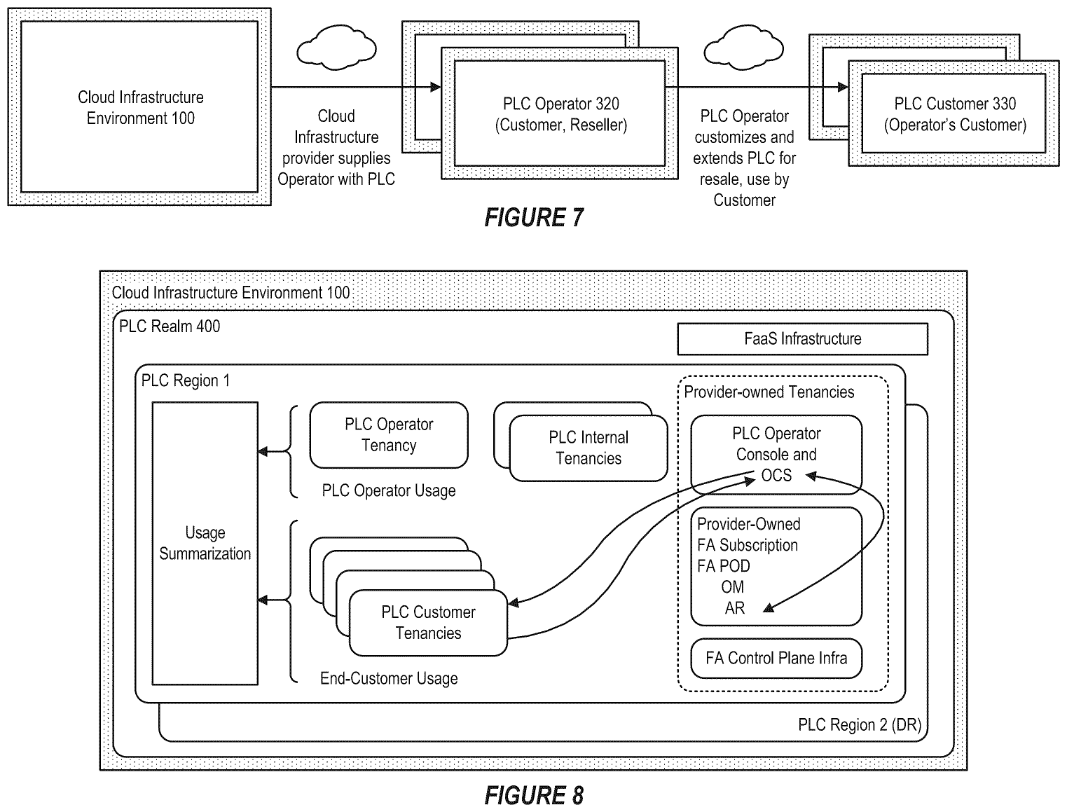

FIG. 7 illustrates how the system can provide dedicated or private label cloud environments for use by tenants or customers of a cloud infrastructure environment in accordance with an embodiment.

As illustrated in FIG. 7, in accordance with an embodiment, a cloud infrastructure provider (e.g., OCI) can supply a PLC operator 320, for example an OCI customer operating as a reseller, with one or more private label cloud (PLC) environments. The PLC operator/reseller can then customize and extend the private label cloud for use by (their) customer 330 for use in accessing subscription-based software products, services, or other offerings associated with the cloud infrastructure environment.

For purposes of illustration, examples of such subscription-based products, services, or other offerings may include various Oracle Cloud Infrastructure software products, Oracle Fusion Applications products, or other types of products or services that allow customers to subscribe to usage of those products or services.

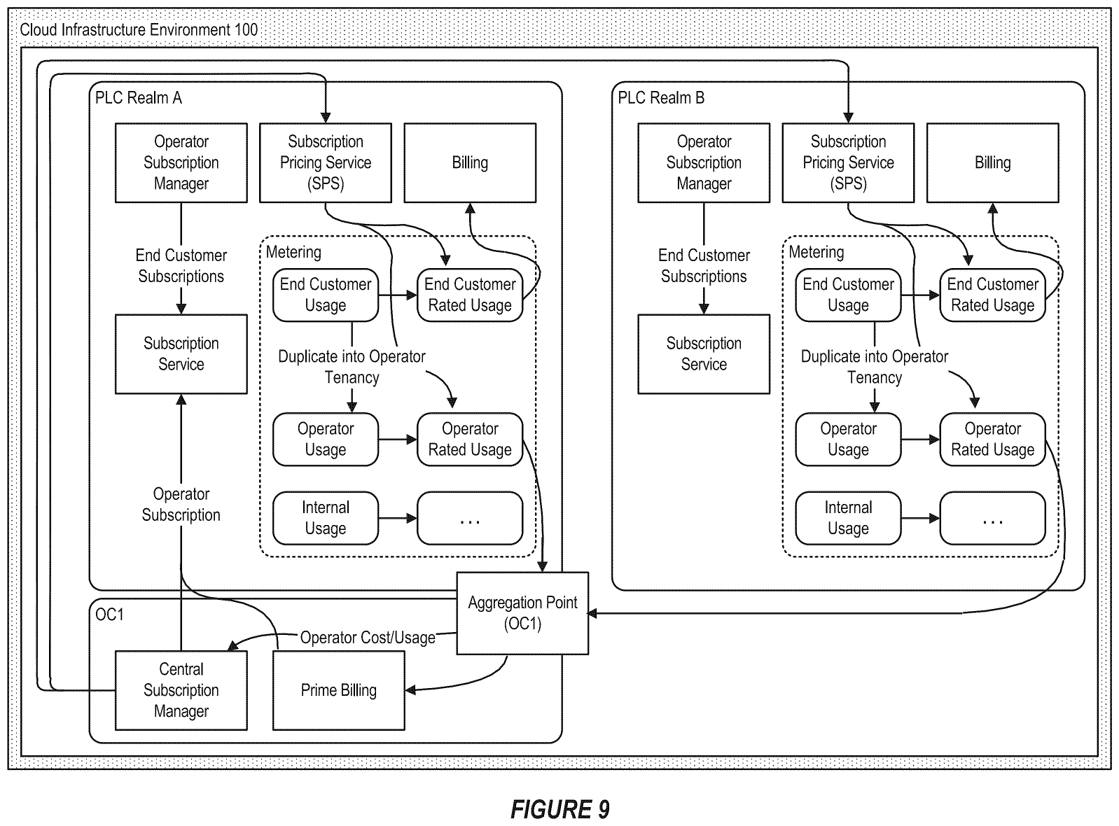

FIG. 8 further illustrates the use of private label cloud realms for use by tenants or customers of a cloud infrastructure environment in accordance with an embodiment.

As illustrated in FIG. 8, in accordance with an embodiment, the system can include a cloud subscription service or component, such as an Oracle Cloud Subscriptions (OCS) service or component, that exposes one or more subscription management APIs for creating orders used to onboard new customers or to launch a workflow that creates a subscription and orchestrates billing and pricing service or other components for use with a PLC realm 400.

In accordance with an embodiment, when a PLC operator or their customer requests a PLC environment, the system creates a PLC realm for use with one or more provider-owned tenancies. A realm is a logical collection of one or more cloud regions that are isolated from each other and do not allow customer content to traverse realm boundaries to a region outside that realm. Each realm is accessed separately. PLC operators access cloud resources and services through a cloud tenancy. A cloud tenancy is a secure and isolated partition of a cloud infrastructure environment, and it only exists in a single realm. Within this tenancy, operators can access services and deploy workloads across all regions within that realm if policies allow.

In accordance with an embodiment, a first step in the process is to create an operator tenancy for the PLC operator before the realm and associated regions are turned over to them for subsequent management. The PLC operator then becomes the administrator of this tenancy with the ability to view and manage everything that happens within that realm, including their customer accounts and usage by those customers of cloud resources.

Generally, once the realm has been turned over or provided to the PLC operator, the cloud infrastructure provider cannot subsequently access the data within the operator tenancy unless the operator authorizes the cloud infrastructure provider to do so, for example, to provide troubleshooting for issues that may arise.

In accordance with an embodiment, the PLC operator can then create additional internal tenancies, intended for their own use internally, for example, to assess what the end customer experience will be, to provide a sales demo tenancy, or to operate a database for their own internal use. The operator can also create one or more customer tenancies that the end customer will be the administrator for. Cloud infrastructure usage metrics, for example, compute usage, storage usage, and usage of other infrastructure resources, may be consolidated by the operator, reflecting both operator usage and customer usage. Cloud infrastructure usage may be reported to the cloud infrastructure provider.

In accordance with an embodiment, a user interface or console can be provided that allows the PLC operator to manage its customer accounts and customer-offered services. A cloud infrastructure provider can also use a cloud infrastructure tenancy, for example, a Fusion Applications tenancy, to install any needed infrastructure services for use by the operator and their customers.

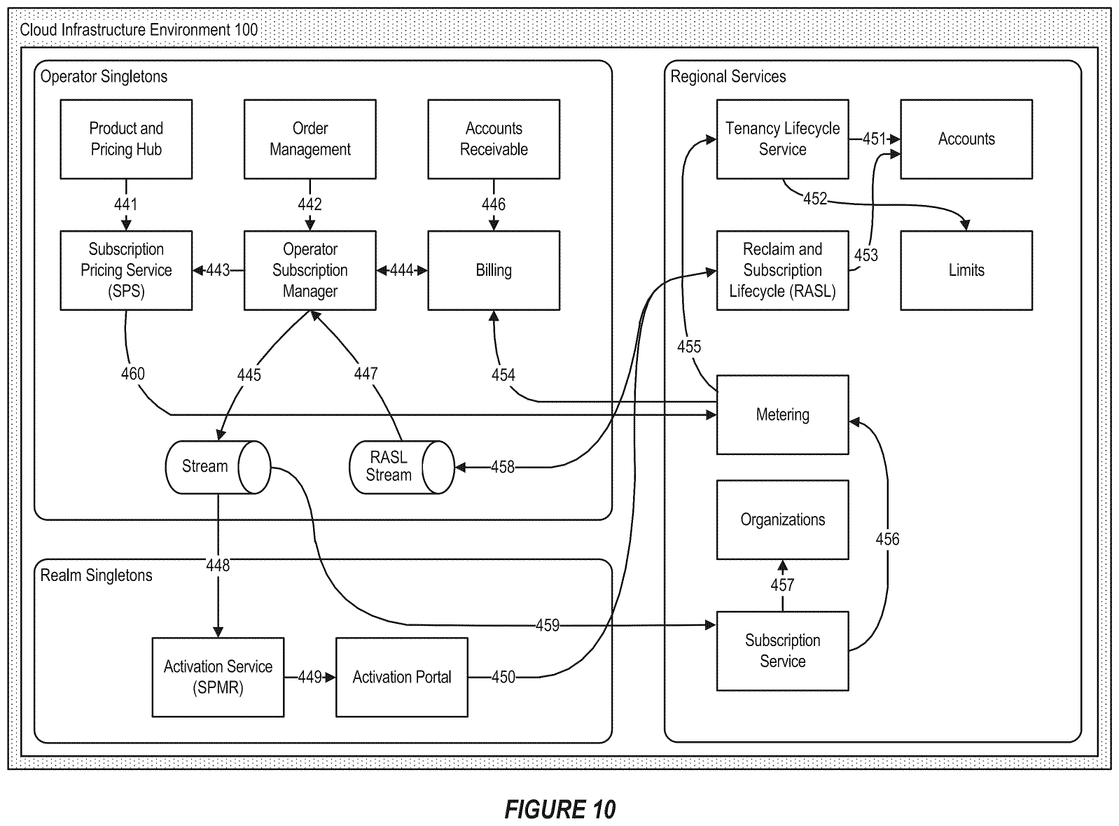

FIG. 9 further illustrates the use of private label cloud realms for use by tenants or customers of a cloud infrastructure environment in accordance with an embodiment.

As illustrated in FIG. 9, in accordance with an embodiment, a cloud subscription service or component exposes one or more subscription management APIs for creating orders used to onboard new customers or to launch a workflow that creates a subscription and orchestrates billing and pricing services or other components.

In accordance with an embodiment, the system can also include a billing service or component that operates upon a billing account or logical container of subscriptions and preferences used to produce an invoice for a customer.

In accordance with an embodiment, the system can also include a subscription pricing service (SPS) or component that operates upon a product catalog that defines the products that can be purchased by a customer. The subscription pricing service can also be used to provide a price list (e.g., a rate card) that the pricing service also owns.

In accordance with an embodiment, to support the sales process used to create a subscription in a PLC realm, products can be selected from a product hub. Once an order is created, a subscription is created in cloud subscription service that thereafter manages the life cycle of that subscription and provisions what needs to be provisioned in downstream services. The SPS component then manages the aspects of pricing and usage for use in charging the end cost to the PLC operator or their ability to charge their customers. Usage events are forwarded to the billing service or component, where, depending on the billing preferences of the subscription, invoices are created and pushed to an accounts receivables component.

In accordance with an embodiment, although the services that are offered in a realm report their usage to a metering service or component, such usage does not have any price associated with it. A rating process determines how much each specific event costs, for example, by applying rate cards, determines a unit and cost for that subscription, associates the cost to that record, and then forwards that to the billing service or component.

As further illustrated in FIG. 9, in accordance with an embodiment, a PLC operator may control multiple realms A, B. For, example an operator that operates in multiple countries may wish to operate a data center that is completely isolated for the United States of America and a separate data center that is completely isolated for Europe, for example, to address governance or regulatory requirements. In accordance with an embodiment, the usage associated with these multiple realms can be aggregated for use in billing the operator.

The examples of various systems illustrated above are provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Private Label Cloud Subscriptions

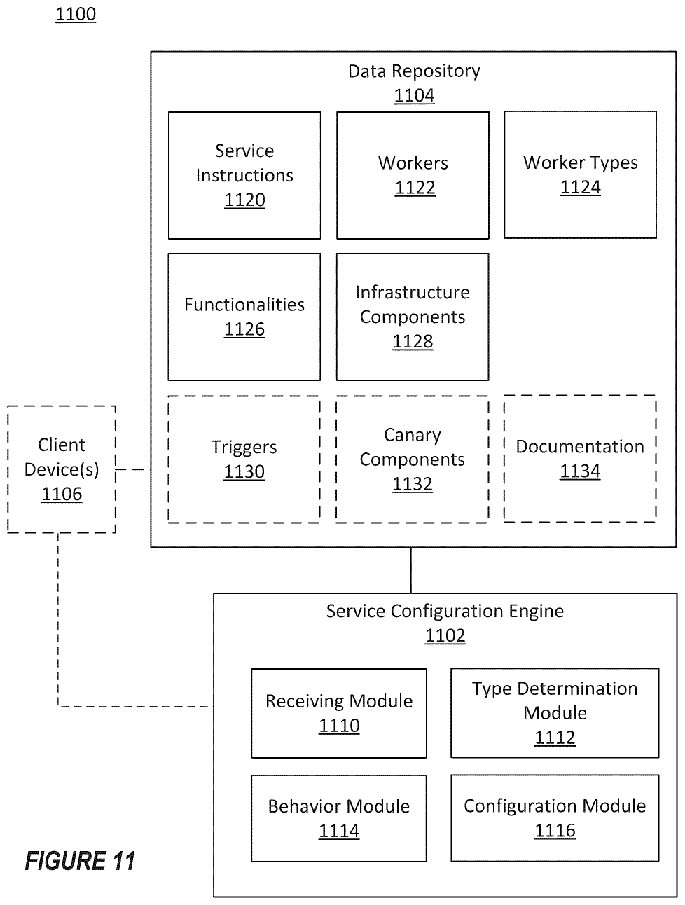

FIG. 10 illustrates a system for providing access to software products or services in a cloud computing or other computing environment in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various Oracle Cloud Infrastructure (OCI) software products, Oracle Fusion Applications products, or other types of products or services that allow customers to subscribe to usage of those products or services.

In accordance with an embodiment, a subscription can include artifacts, such as products, commits, billing model, and state. The cloud subscription service can expose one or more subscription management APIs for creating orders used to onboard new customers or to launch a workflow that creates a subscription and orchestrates creating the proper footprints in billing and pricing service or components as further described below.

In accordance with an embodiment, the billing service or component operates upon a billing account or logical container of subscriptions and preferences used to produce an invoice. Each billing account generates one or more invoices per billing cycle. The billing service includes a first pipeline that accepts usage and cost from a metering service or component. Usage may be accepted through a REST API or another interface. The billing service writes the usage to a database from which balances may be calculated and aggregated by the billing service or other services. The billing service may include a second pipeline responsible for taking the aggregated usage and commitments and calculating charges over one or more billing intervals.

In accordance with an embodiment, the subscription pricing service (SPS) or component operates upon a product catalog that defines the products that can be purchased by a customer. The product catalog forms the backbone of a price list (i.e., rate card) that the pricing service also owns. Rate cards are modeled as pricing rules on top of public list prices. The pricing service maintains a single price list for each product; new product prices can be added and existing prices changed. The price list has a full history, the latest version being the current rate card. Since some contracts may require a snapshot of the rate card be taken, the pricing service handles this by recording the time a customer's rate card is created and then querying the price list at that time.

In accordance with an embodiment, the SPS or pricing service is responsible for providing information about products, global price lists, and end customer subscription specific price lists and discounts. For example, in accordance with an embodiment, the SPS can sync product information from a product hub (e.g., an Oracle Fusion Product Hub) and a global price list from a pricing hub (e.g., an Oracle Fusion Pricing Hub).

In accordance with an embodiment, the cloud subscription service operates as an upstream service to receive new order requests, for example, from an Oracle Fusion Order Management environment. The cloud subscription service can provide subscription information to the SPS service. Subscription details like time of quote, configuration, and subscription type (Commitment, PayG) help SPS to determine an effective base price (Rate Card) for the subscription. The cloud subscription service can also send discounts for subscriptions received, for example, from Oracle Fusion Order Management, that SPS stores as a pricing rule entity.

In accordance with an embodiment, the SPS service runs as a background process to manage a rate cards service or component responsible for generating rate cards for new subscriptions and updating when new price changes occur. The SPS service can expose APIs to access rate cards and pricing rules. A metering in-line rating engine can utilize these APIs to get subscription-specific rate cards and pricing rules using this data for cost calculations.

In accordance with an embodiment, additional SPS components can include, for example, a Pricing/Product Hub Oracle Integration Cloud (OIC) integration component, that allows a PLC operator entity providing subscription-based products, services, or other offerings within the environment to manage their product and price list, for example, as provided by an Oracle Fusion Product Hub and Oracle Fusion Pricing Hub, respectively.

For example, in accordance with such an embodiment, an SPS OIC product integration flow can listen to create/update events in the Product Hub and make calls to an SPS product API. Similarly, an SPS OIC pricing integration flow can pull new price list creations from the Pricing Hub and call respective SPS pricing APIs.

In accordance with an embodiment, the system can also include an SPS core module that provides APIs to manage and access pricing entities. Pricing can be accessed by internal services, such as an inline rating engine.

In accordance with an embodiment, the system can also include a rate card manager component. The SPS service maintains the single base price for a product at a given time. However, product prices for subscriptions are dependent on a base price at quote configuration time and price list change policy attributes of subscriptions. The SPS service internally maintains the price to be used for subscriptions using these properties. Such price lists are grouped in a rate card. The rate card manager can create and maintain the rate card as well as listen to price list changes and update existing rate cards with the new price. It also listens to new subscriptions and assigns the rate card based on subscription properties.

In accordance with an embodiment, the system can also include a rule decoder engine. The SPS service is responsible for managing pricing rules for a subscription, including discounts offered to an end customer. Pricing rules eligibility can be based on attributes of Products, like Discount group, Product Category, or specific SKUs. Internally, SPS needs to identify the list of products these rules will be applicable. To accomplish this, the rule decoder engine can compile the pricing rules in a format such that an in-line rating engine can consume for cost calculation. This compilation process can be triggered when products or pricing rules get created/updated.

As illustrated by way of example in FIG. 10, in accordance with an embodiment: at 441, a product and price information managed in, e.g., Fusion Applications, is sent to the SPS component. At 442, orders are sent to the cloud subscription service component to create subscriptions, rate cards, and billing accounts. At 443, pricing configuration and pricing rules are sent to SPS for new orders. At 444, the cloud subscription service is used to set up a billing account in the billing service or component. At 445, the cloud subscription service publishes events to a cloud infrastructure streaming component. At 446, charge data is sent to an accounts receivable component to generate invoices. At 447, cloud subscription service consumes reclaim and subscription lifecycle (RASL) events from cloud infrastructure streaming. At 448, an activation service reads the cloud subscription service event stream. At 449, a customer gets activation data from a portal. At 450, a tenancy lifecycle service provisions a tenancy as part of the subscription activation. At 451, the tenancy lifecycle service creates an accounts footprint during account provisioning. At 452, the tenancy lifecycle service sets a limits template during account provisioning. At 453, the accounts component acts as a downstream RASL client to handle legacy reclamation. At 454, aggregated cost and usage is sent to the billing service or component. At 455, an organization can create child tenancies using the tenancy lifecycle service. At 456, a metering service or component gets subscription mapping data. At 457, the subscription service gets organization data for subscription mappings. At 458, RASL reads cloud subscription service event stream. At 459, the subscription service reads cloud subscription service event stream; and at 460, the metering service or component gets a rate card data for each subscription that can then be used in charging the end cost to the PLC operator or their ability to charge their customers.

The above example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### 2. Access Control Architecture

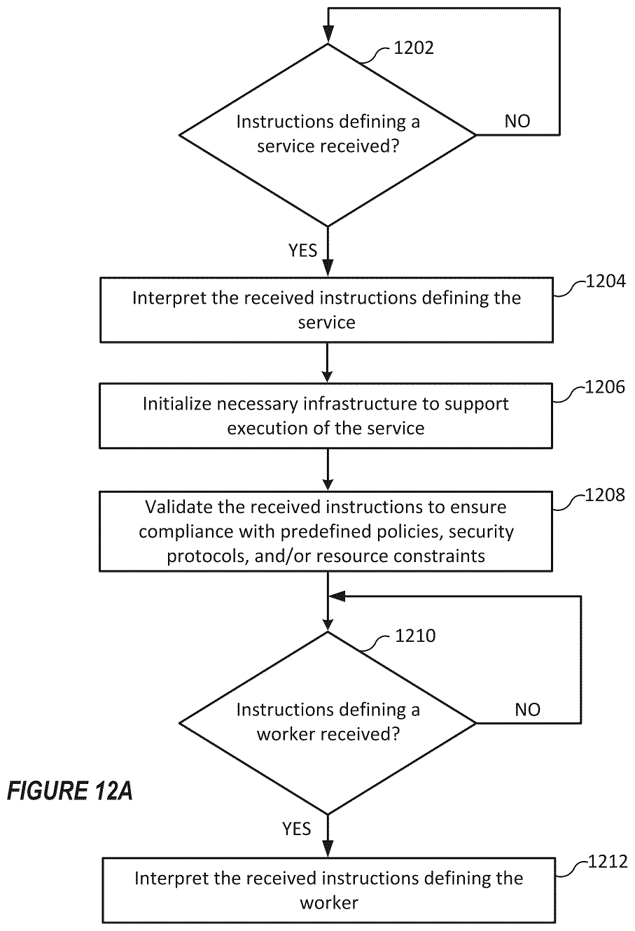

FIG. 11 illustrates a system 1100 for configuring and deploying services in a cloud environment in accordance with one or more embodiments. As illustrated in FIG. 11, system 1100 includes a service configuration engine 1102, a data repository 1104 communicatively coupled to the service configuration engine 1102, and one or more optional client devices 1106 which may be communicatively coupled to one or both of the service configuration engine 1102 and the data repository 1104. The data repository 1104 may include several repositories of data, including repositories for one or more of: service instructions 1120, workers 1122, worker types 1124, behaviors 1126, network components 1128, security protocols 1130, triggers 1132, canary components 1134, and/or documentation 1136. The service configuration engine 1102 may include one or more modules, including one or more of: a receiving module 1110, a type determination module 1112, a behavior module 1114, and/or a configuration module 1116. In one or more embodiments, the system 100 may include more or fewer components than the components illustrated in FIG. 11. The components illustrated in FIG. 11 may be local to or remote from each other. The components illustrated in FIG. 11 may be implemented in software and/or hardware. Each component may be distributed over multiple applications and/or machines. Multiple components may be combined into one application and/or machine. Operations described with respect to one component may instead be performed by another component.

In one or more embodiments, a data repository 1104 is any type of storage unit and/or device (e.g., a file system, database, collection of tables, or any other storage mechanism) for storing data. Further, a data repository 1104 may include multiple different storage units and/or devices. The multiple different storage units and/or devices may or may not be of the same type or located at the same physical site. Further, a data repository 104 may be implemented or executed on the same computing system as the service configuration engine 1102. Additionally, or alternatively, a data repository 104 may be implemented or executed on a computing system separate from the service configuration engine 1102. The data repository 1104 may be communicatively coupled to the service configuration engine 1102 or the client device(s) 1106 via a direct connection or via a network.

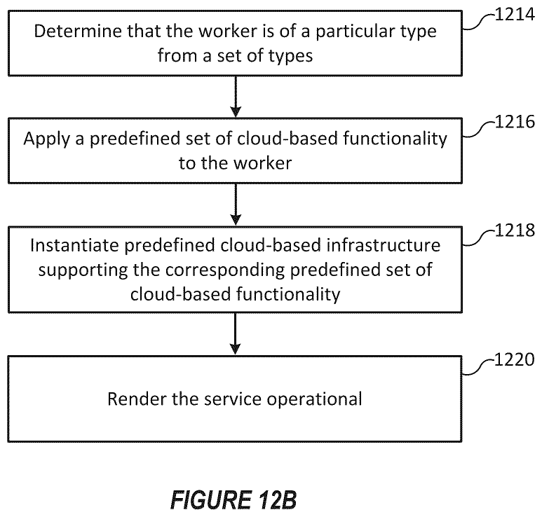

Within the data repository 1104, one or more repositories for data may be included, as illustrated. Such repositories may include but are not necessarily limited to the following. Service instructions 1120 refer to instructions, received by the system 1100, that define a service. Workers 1122 refer to units within a service that perform specific tasks within the service. Worker types 1124 refer to prespecified types which may apply to workers 1122. Workers 1122 may include, for example, “frontend” type workers which interact with users or external systems, or “workflow” type workers which perform tasks within the service's workflow. Functionalities 1126 refer to predefined sets of cloud-based functionalities or properties assigned to workers 1122 that define their capabilities. Examples of sets of functionalities may include “caller” functionalities for calling other services, “listener” functionalities for responding to incoming requests, and “asynchronous” functionalities which trigger based on events. Infrastructure components 1128 may refer to network infrastructure components and security components which may be instantiated by the cloud environment based on the worker types and functionalities that have been determined or defined for the service. Optional triggers 1130 refer to defined events that can wake up asynchronous workers and initiate execution of their functionalities. Optional canary components 1132 refer to components used to perform automated testing of the service. Optional documentation 1134 refers to information or context relating to a service, including, for example, its configuration and usage instructions. These various pieces of data are described in further detail below with respect to FIG. 12.

In an embodiment, the service configuration engine 1102 performs operations described below with respect to FIG. 12, to enhance software extensibility in cloud environments. The service configuration engine 1102 may include a number of modules, including the following. Receiving module 1110 is configured to receive service configuration instructions and worker configuration instructions. Type determination module 1112 is configured to analyze the configuration instructions to determine the types of workers being defined. Behavior module 1114 is configured to determine associations of workers to respective predefined sets of cloud-based functionality based on worker type. Configuration module 1116 is configured to instantiate predefined cloud-based infrastructure that supports the corresponding predefined set of cloud-based functionality. The functions of these modules will be described in further detail below with respect to FIG. 2.

Optional client device(s) 1106 may optionally communicate with the data repository 1104 and/or the service configuration engine 1102. These one or more client devices 1106 represent any devices associated with a user of the system. A client device 1106 may present, for example, one or more user interfaces containing information, content, interactive components, visual data, or any other relevant presentation materials pursuant to the systems and methods herein.

Information describing enhancing software extensibility in cloud environments may be implemented across any of components within the system 1100. However, this information is illustrated within the data repository 1104 for purposes of clarity and explanation. In an embodiment, data repository 1104, service configuration engine 1102, and/or a client device 1106 can be implemented separately or in some combination on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. Providing Software Extensibility in Cloud Environments

FIG. 12A illustrates an example set of operations for providing software extensibility in cloud environments in accordance with one or more embodiments. One or more operations illustrated in FIG. 12A may be modified, rearranged, or omitted all together. Accordingly, the particular sequence of operations illustrated in FIG. 12A should not be construed as limiting the scope of one or more embodiments.

In an embodiment, the system determines whether a cloud environment has received instructions that define a service to be executed within the cloud environment (Operation 1202). One or more embodiments provide a cloud environment such as the cloud infrastructure environment of FIG. 1. One or more embodiments act as a recipient of these instructions. If the system determines that instructions defining a service have not yet been received, then the system continues to monitor for whether such instructions have been received. If the system determine that instructions defining a service have been received, then the system continues on to Operation 1204, described in detail below.

In various embodiments, the instructions defining the service are transmitted through one or more transmission or communication channels. One or more embodiments transmit the instructions via APIs, which provide a structured and programmable interface for interacting with the cloud environment. Such APIs allow developers to programmatically define cloud services and their associated components and functionality. One or more embodiments provide a graphical user interface (GUI) and a set of GUI-based tools, which offer a visual, interactive workflow for defining cloud services. GUI-based tools often provide, for example, drag-and-drop functionality and visual feedback. Beyond APIs and GUIs, other communication channels such as command-line interfaces (CLIs), configuration files, or direct programmatic interfaces may also be utilized in different embodiments to transmit the instructions, ensuring versatility and accessibility across diverse user interfaces and environments.

The instructions received by the cloud environment provide detailed specifications for the structure, functionality, and behavior of the service being defined. These specifications encompass elements such as the composition of the service's components as well as their roles, responsibilities, and interactions. They may also detail, for example, communication, synchronization, and data flow pathways, error handling, fault tolerance strategies, or scalability provisions.

In an embodiment, the system interprets the received instructions to understand the composition and objectives of the service (Operation 1204). This interpretation may involve parsing the instructions to identify key components, such as service dependencies, communication protocols, and security requirements. Additionally, the instructions may include configuration parameters dictating how the service should interact with other components of the cloud environment, such as storage systems, databases, or external APIs. The system may further analyze the instructions to determine resource allocation, scalability requirements, and/or performance optimization strategies defined or referenced in the specific service instructions.

In an embodiment, the system initializes the necessary infrastructure to support the execution of the service (Operation 1206). One or more embodiments provision the infrastructure by allocating virtualized compute resources, such as virtual machines or containers. This process may involve configuring networking components, including virtual networks, subnets, and firewalls, to establish communication pathways and enforce security policies within the cloud environment. Additionally, the system may allocate storage resources, such as object storage buckets or block storage volumes, to store data and assets associated with the service. Furthermore, it may deploy monitoring and logging services to track resource utilization, performance metrics, and operational logs for ongoing management and optimization. Finally, the system may implement automated scaling policies to dynamically adjust resource allocations based on workload demands and performance thresholds.

In an embodiment, the cloud environment validates the received instructions to ensure compliance with predefined policies, security protocols, and/or resource constraints (Operation 1208). For example, the cloud environment may validate the instructions to verify that they adhere to predefined architectural guidelines, naming conventions, and/or access control policies established by the cloud environment or the tenant. One or more embodiments perform security scans and vulnerability assessments to identify and mitigate potential security risks or vulnerabilities in the service configuration. One or more embodiments enforce resource quotas or usage limits to prevent over-provisioning of resources or unauthorized access to sensitive data. One or more embodiments may additionally perform compatibility checks to ensure that the service configuration is compatible with the underlying infrastructure and platform services. One or more embodiments may further conduct performance testing and optimization to validate that the service can meet specified performance requirements and service level agreements (SLAs) under expected workload conditions.

In an embodiment, the system receives, by the cloud environment, instructions that define a worker in the set of workers (Operation 1210). These workers are specifically configured by the instructions to collaboratively execute various cloud-based operations. Workers, in this context, refer to discrete software components or modules tasked with performing specific functions within the service. Each worker is defined by the instructions to fulfill a particular role or responsibility within the broader context of the service, contributing to its overall functionality and operation. One or more embodiments include instructions which define workers by a particular name or worker type which is understood within the system to refer to a known set of worker functionalities and behaviors. One or more embodiments include instructions which particularly outline specific characteristics, capabilities, or interactions of each worker. Such instructions delineate workers' individual tasks, dependencies, and/or interfaces within the service architecture. The worker is configured to perform a subset of the one or more cloud-based operations. If the system determines that instructions defining a worker have not yet been received, then the system continues to monitor for whether such instructions have been received. If the system determine that instructions defining a worker have been received, then the system continues on to Operation 1206, described in detail below.

The cloud environment acts as a receiver, accepting instructions transmitted from various sources to define the characteristics and functionality of the worker. Various embodiments may involve these instructions originating from, e.g., a user interface, an API, or other communication channels through which users interact with the cloud environment. For example, a user may utilize a GUI provided by the cloud service provider to specify the attributes and behaviors of the worker, such as its computational tasks, data processing functions, or communication protocols.

One or more embodiments facilitate the receipt of instructions by establishing communication channels between the cloud environment and external entities, ensuring transmission of data and commands. These embodiments may utilize, for example, network protocols, encryption mechanisms, and authentication procedures to securely receive and validate the instructions defining the worker. For instance, the cloud environment may employ secure sockets layer (“SSL”) encryption to protect data transmission over the internet, safeguarding the integrity and confidentiality of the received instructions. Additionally, authentication mechanisms such as digital signatures or access control lists may be employed to verify the identity and authorization of users or systems transmitting the instructions.

In an embodiment, the system interprets and processes the received instructions defining the worker (Operation 1212). The system extracts relevant parameters and configurations defining the characteristics of the worker. One or more embodiments may include, e.g., parsing the instructions, identifying key directives or commands, and extracting metadata specifying the functional requirements and constraints of the worker. For example, the instructions may be represented in a structured data format such as, e.g., JavaScript Object Notation (“JSON”) or Extensible Markup Language (“XML”). This structured data format serves to programmatically parse and extract attributes such as one or more of, e.g., worker type, task assignments, resource allocations, and dependencies.

One or more embodiments include instructions that define the worker as asynchronous. The predefined cloud-based infrastructure is subsequently configured to activate the worker responsive to detecting one or more triggering events. One or more embodiments interpret the instructions defining the worker to identify its asynchronous nature, signifying that it operates independently of the main execution flow and can handle tasks asynchronously. For instance, if the worker is tasked with processing asynchronous events, such as message queues or batch jobs, embodiments recognize this characteristic from the instruction set provided for the worker. Upon recognizing the asynchronous nature of the worker, one or more embodiments configure the predefined cloud-based infrastructure to monitor for triggering events that necessitate the activation of the worker. These triggering events may include, for example, incoming data arrivals, changes in system states, or predefined time intervals. For example, if the worker is designed to process incoming messages from a message queue, one or more embodiments can configure event listeners or polling mechanisms to monitor the queue for new messages.

One or more embodiments implement event-driven mechanisms within the cloud environment to detect and respond to triggering events in a timely manner. For example, embodiments may utilize event-driven architectures, such as, e.g., publish-subscribe models or event-driven programming paradigms, to efficiently manage asynchronous tasks and trigger the activation of the worker when needed.

One or more embodiments employ real-time monitoring and alerting systems to proactively detect triggering events and initiate the activation of the worker in response to predefined conditions. For example, if the worker is responsible for processing time-sensitive data streams, embodiments may configure one or more monitoring agents to detect anomalies or threshold breaches in the data flow and trigger the worker's activation accordingly.

One or more embodiments incorporate fault-tolerant mechanisms and retry policies to ensure reliable activation of the worker in case of failures or transient errors. For example, if the activation of the worker fails due to network issues or service unavailability, embodiments may implement retry logic or exponential backoff strategies to retry activation attempts and ensure eventual successful execution.

FIG. 12B illustrates an example set of operations for providing software extensibility in cloud environments, in accordance with one or more embodiments. In an embodiment, FIG. 12B continues the set of operations from FIG. 12A. One or more operations illustrated in FIG. 12B may be modified, rearranged, or omitted all together. Accordingly, the particular sequence of operations illustrated in FIG. 12B should not be construed as limiting the scope of one or more embodiments.

In an embodiment, based on the instructions that define the worker that the system received and interpreted (e.g., in Operations 1210 and 1212 from FIG. 12A, respectively), the system determines, by the cloud environment, that the worker is of a particular type of a prespecified set of types (Operation 1214). The prespecified set of types is associated with respective predefined sets of cloud-based functionality, based on the instructions defining the worker. One or more embodiments analyze, e.g., the attributes, characteristics, and configurations specified in the instructions to classify the worker into one of the predefined types. For example, embodiments may examine, e.g., metadata, annotations, or tags included in the instructions to identify indicators or patterns indicative of the worker's type.

One or more embodiments utilize machine learning (ML) algorithms to automatically categorize the worker based on predefined criteria or training data. Various such embodiments may employ ML techniques such as, e.g., supervised learning, unsupervised learning, or semi-supervised learning to analyze the characteristics and features of the worker and make informed decisions regarding its type classification. Supervised learning algorithms, for example, can be trained on labeled datasets where each worker is associated with its corresponding type. During the training phase, the algorithms learn to recognize patterns and relationships between the attributes of the workers and their respective types, allowing them to generalize this knowledge to classify unseen workers accurately. As another example, unsupervised learning algorithms can automatically identify clusters or groups of workers with similar characteristics, enabling the discovery of latent structures and patterns in the data without explicit labeling. These algorithms can detect inherent similarities or dissimilarities between workers and group them into distinct categories based on their shared attributes. Other embodiments may employ semi-supervised learning approaches that combine labeled and unlabeled data to refine the classification process iteratively.

One or more other embodiments additionally or alternatively utilize rule-based classifiers to perform automatic categorization of the worker based on a set of predefined rules. Such embodiments may utilize a set of predefined rules or decision criteria established by, e.g., domain experts or system administrators, in order to categorize the worker into specific types. One or more embodiments include rule-based classifiers which operate by sequentially evaluating the worker's attributes or properties against the predefined rules to make classification decisions. Each rule defines conditions or thresholds based on various factors such as the worker's functionality, behavior, or configuration parameters. For example, a rule may specify that if a worker includes specific keywords in its code or if it utilizes APIs, it should be categorized as a “frontend” type. Such a “frontend” type worker may be configured to process incoming requests from external sources and perform one or more actions. Similarly, another rule may dictate that if a worker handles asynchronous tasks or event-driven processes, it should be classified as a “workflow” type. Such a “workflow” type worker may be configured to manage sequential or parallel execution of tasks within the service. One or more embodiments may stipulate that if no predefined rules apply to a worker, it should be classified as a “generic” or “custom” type. Such a type may be configured to perform one or more defined custom actions not covered by other types in the set of types, where the custom action is defined by the user via the instructions. By applying these rules systematically, the rule-based classifiers can assign the worker to the most appropriate type category. This approach offers transparency and interpretability in the classification process, as the reasoning behind each classification decision is explicitly defined by the rules. Furthermore, it allows for flexibility in adapting the classification criteria to accommodate evolving requirements or domain-specific considerations.

One or more embodiments perform the determination of the worker's type by comparing the attributes and behaviors specified in the instructions against a predefined taxonomy or ontology of worker types. This taxonomy defines a hierarchical classification scheme wherein each type is associated with a distinct set of functionalities, capabilities, or roles within the cloud environment. One or more embodiments utilize semantic matching techniques, such as, e.g., ontology alignment or similarity matching, to assess the degree of correspondence between the characteristics of the worker and the prespecified attributes associated with each predefined type. For example, if the instructions specify characteristics indicative of a data processing task, embodiments may classify the worker as a “data processing” type, which is associated with functionalities tailored for handling and analyzing large datasets.

One or more embodiments utilize heuristics or decision trees to infer the worker's type based on contextual information and domain-specific knowledge. One or more embodiments leverage one or more of, e.g., statistical methods, probabilistic models, or expert systems to evaluate the relevance and significance of different attributes in determining the worker's type. For example, if the instructions include keywords or domain-specific terminology associated with machine learning algorithms, embodiments may infer that the worker belongs to a “machine learning” type, which is specialized in executing and managing machine learning tasks.

One or more embodiments additionally involve utilization of various contextual factors such as historical data or prior user activity. For example, one or more embodiments utilize historical usage patterns, which refer to, e.g., the past usage, behavior, configurations, or definitions of similar workers or services within the cloud environment. By analyzing how similar workers have been utilized or configured in the past, embodiments can infer patterns or trends that help in classifying the current worker. This analysis may include factors such as, for example, the frequency of usage, the types of operations performed, or the interaction patterns with other components in the environment.

One or more embodiments utilize prior user activity or known user preferences in the categorization process. Users or administrators may have specific preferences or expectations regarding the behavior or functionality of the workers they deploy. One or more embodiments take such preferences into account when categorizing the worker, ensuring that it aligns with the user's intended usage or requirements. This may involve customizable classification criteria or user-defined rules that prioritize certain attributes or characteristics of the worker. One or more embodiments determine user preferences based on prior user activity. For example, the system may analyze the frequency and types of operations performed by users with similar roles or responsibilities. By examining historical user interactions with various types of workers or services, embodiments can identify patterns and preferences that inform the classification process. Additionally, user feedback mechanisms, such as user surveys or feedback forms, may be utilized to gather explicit preferences or requirements. This feedback can provide valuable insights into the user's expectations regarding the functionality, performance, or integration capabilities of the worker.

One or more embodiments make use of known system configurations, which provide relevant contextual information that can influence the classification decision. The configuration settings of the cloud environment, such as, e.g., resource allocations, network configurations, or security policies, can impact the behavior and functionality of the workers deployed within it. By considering these configurations as part of the classification process, embodiments can ensure that the assigned worker type is compatible with the overall system architecture and requirements.

In an embodiment, responsive to determining that the worker is of the particular type, the system applies, by the cloud environment, a corresponding predefined set of cloud-based functionality to the worker (Operation 1216). One or more embodiments access a repository or database containing predefined sets of functionalities mapped to different worker types. One or more embodiments retrieve the relevant set of functionalities associated with the determined worker type and apply them to the worker. For example, if the determined worker type is “frontend,” one or more embodiments would apply a set of functionalities tailored to user interface interactions and client-side processing. Various embodiments may involve these predefined sets including one or more of, e.g., access controls, resource management policies, communication protocols, and error handling mechanisms tailored to the specific requirements and constraints of each worker type. For example, if the worker is classified as a “real-time processing” type, embodiments may apply, e.g., low-latency communication protocols, dynamic scaling policies, and fault-tolerant mechanisms to optimize its performance and reliability in processing data streams.

One or more embodiments apply the predefined set of cloud-based functionality by configuring the runtime environment of the worker. This may include, for example, setting up execution environments, allocating resources such as CPU, memory, and storage, or configuring access permissions based on the predefined functionality requirements. For example, if the predefined functionality involves data processing tasks, embodiments ensure that the worker has sufficient computing resources and access permissions to interact with relevant data sources.

One or more embodiments include the integration of third-party services or APIs to enhance the functionality of the worker within the cloud environment. This integration process allows the worker to make use of external resources and capabilities. For instance, if the predefined functionality of the worker necessitates interactions with a specific cloud-based service tailored for data analytics, one or more embodiments facilitate integration by configuring the requisite API endpoints and authentication mechanisms.

To elaborate, when integrating with third-party services or APIs, one or more embodiments first identify the specific services or APIs required to augment the functionality of the worker based on the predefined criteria or specifications. Subsequently, one or more embodiments establish communication channels between the worker and the external services by configuring API endpoints, which serve as the entry points for exchanging data and requests. Additionally, one or more embodiments implement authentication mechanisms to ensure secure access to the external services, verifying the identity and permissions of the worker before initiating interactions.

For example, consider a scenario where the predefined functionality of the worker entails real-time data analysis and visualization. In such cases, embodiments identify and integrate with a specialized cloud-based service known for its advanced analytics capabilities. By configuring the necessary API endpoints, embodiments allow the worker to transmit data to the external service for analysis and receive processed results in return. Moreover, authentication mechanisms, such as API keys or authentication tokens (e.g., OAuth tokens), are implemented to authenticate the worker's identity and authorize access to the analytics service, safeguarding against unauthorized usage or data breaches.

One or more embodiments dynamically adjust the applied functionality based on runtime conditions or user preferences. For example, if the workload of the worker increases beyond a certain threshold, one or more embodiments automatically scale up the allocated resources or activate additional functionalities to meet the demand. Similarly, if users specify custom preferences or configurations for the worker, one or more embodiments accommodate these preferences by selectively applying or customizing the predefined functionality accordingly.

In an embodiment, the system instantiates, by the cloud environment, predefined cloud-based infrastructure that supports the corresponding predefined set of cloud-based functionality (Operation 1218). One or more embodiments initiate the instantiation process by identifying the specific type of infrastructure components and resources required to support the functionalities of the determined worker type. For instance, if the worker type is associated with data processing and analytics tasks, one or more embodiments may instantiate, e.g., cloud-based compute instances, storage volumes, and specialized analytical tools or frameworks tailored to such operations. These infrastructure components are provisioned dynamically based on the predefined requirements and specifications associated with the worker type.

For example, consider a scenario where the determined worker type is designated for high-performance computing tasks, such as scientific simulations or rendering complex graphics. In such cases, one or more embodiments may instantiate virtual machines with optimized CPU and GPU configurations, allocate high-speed storage volumes for data processing, and deploy specialized software libraries or frameworks for parallel computing and visualization.

Furthermore, one or more embodiments may employ automation techniques to streamline the instantiation process and ensure rapid deployment of the required infrastructure components. Automation tools, such as, e.g., orchestration platforms or Infrastructure as Code (“IaC”) frameworks, allow one or more embodiments to define infrastructure configurations programmatically and execute deployment tasks efficiently.

For example, one or more embodiments may utilize declarative templates, such as, e.g., AWS CloudFormation or Terraform scripts, to specify the desired state of the cloud-based infrastructure and automate the provisioning process. These templates describe the desired resource topology, configuration settings, and dependencies, allowing embodiments to instantiate and configure the infrastructure in a consistent and reproducible manner.

One or more embodiments may additionally or alternatively incorporate scalability and elasticity features into the instantiated infrastructure to accommodate fluctuating workloads and demand patterns. For example, by leveraging auto-scaling groups, load balancers, and elastic storage solutions, various embodiments ensure that the cloud-based infrastructure can dynamically adapt to changing resource requirements and optimize resource utilization.

One or more embodiments of the invention configure the predefined cloud-based infrastructure to allow communication between the first worker and various entities, including one or more of, e.g., other workers within the service, external services, or the broader internet. One or more embodiments establish communication channels between the first worker and other workers within the same service, allowing them to exchange information, share resources, or coordinate tasks. For example, if the first worker processes incoming data streams and generates output for further processing by a second downstream worker, embodiments configure network connectivity and messaging protocols to facilitate the flow of data between the first and second interconnected workers.

Additionally or alternatively, one or more embodiments facilitate communication between the worker and one or more external services or APIs, leveraging predefined integration mechanisms and protocols. For example, if the worker interacts with third-party data sources or analytics services for processing external datasets, embodiments can configure, e.g., API endpoints, authentication mechanisms, and data transfer protocols to facilitate communication with these external entities.

Additionally or alternatively, one or more embodiments establish connectivity between the first worker and internet-based services or resources, allowing it to access external data sources, APIs, or web services. For example, if the first worker performs web scraping or interacts with publicly available APIs to retrieve real-time data feeds, embodiments can automatically configure, e.g., network routing, security policies, and firewall rules to facilitate communication with internet-based endpoints.

Additionally or alternatively, one or more embodiments may implement communication protocols and standards such as, for example, HTTP, RESTful APIs, WebSocket, or Message Queuing Telemetry Transport (“MQTT”) to facilitate interoperability and data exchange between the first worker and other entities. These protocols ensure compatibility and allow integration with a wide range of services and systems, enhancing the versatility and extensibility of the cloud-based infrastructure.

One or more embodiments include, within the predefined cloud-based infrastructure, one or more canary components configured to test whether the service is operational. A “canary component” refers to a specialized monitoring tool or software module deployed within a system to detect and mitigate potential issues or anomalies before they impact the overall system's functionality. The primary purpose of a canary component is to act as an “early warning system” to proactively identify potential issues, such as configuration errors, performance degradation, or security vulnerabilities, before they escalate into critical problems or outages. By continuously monitoring the system and analyzing incoming data, canary components can trigger alerts or notifications to system administrators or automated remediation systems, enabling timely intervention and mitigation measures.

One or more embodiments deploy canary components alongside the service within the cloud environment. These canary components are lightweight and non-intrusive, and are designed to mimic the behavior of the production environment and closely monitor the performance and behavior of the service. For example, embodiments may deploy canary components that periodically send test requests or simulate user interactions with the service, measuring, e.g., response times, latency, and other performance metrics. By comparing the behavior of the canary components with the expected baseline performance, embodiments can detect deviations or abnormalities indicative of potential issues in the service.

One or more embodiments may additionally or alternatively configure these canary components to perform targeted tests on specific functionalities or critical pathways within the service. For example, if the service includes multiple microservices or components, embodiments may deploy canary components to test each component individually, assessing their resilience and performance under different conditions.

One or more embodiments may additionally or alternatively utilize canary analysis techniques to aggregate and analyze the data collected by the canary components, identifying patterns or trends that may indicate underlying issues in the service. For example, embodiments may employ statistical analysis or machine learning algorithms to detect anomalies in the performance data and trigger alerts or notifications to system administrators. For instance, one or more embodiments may utilize anomaly detection algorithms, such as those based on statistical methods like Gaussian distribution modeling, time-series analysis, or clustering techniques. These algorithms analyze various performance metrics, such as, e.g., response times, CPU utilization, memory usage, and network traffic, to identify patterns indicative of abnormal behavior. By comparing current data to established baselines or training models, anomalies can be detected and flagged for further investigation or action.

One or more embodiments employ predictive modeling techniques, where machine learning algorithms are trained on historical performance data to forecast future trends and anticipate potential anomalies before they occur. These predictive models can detect subtle changes or irregularities in system behavior that may not be immediately apparent through traditional statistical methods.

Once anomalies are detected, one or more embodiments are configured to trigger alerts or notifications to system administrators, providing timely insights into potential issues that require attention. These alerts can be customized based on severity levels or specific criteria, enabling administrators to prioritize and address critical issues promptly. Additionally, automated remediation actions may be initiated in response to detected anomalies, such as scaling resources dynamically to handle increased workload or rolling back changes that may have caused performance degradation.

One or more embodiments may implement automated remediation mechanisms that respond to issues detected by the canary components. For instance, if the canary components identify a degradation in the performance of the service, embodiments may automatically scale up resources, rollback changes, or initiate failover procedures to restore service functionality and minimize downtime.

One or more embodiments include, within the instructions that define the first worker, a parameter that defines for the one or more canary components one or more of: a test sequence; an expected outcome; or a testing frequency. This parameter serves to customize the testing process conducted by the canary components. One or more embodiments may involve defining a test sequence within the instructions, outlining a series of steps or actions that the canary components should perform during the testing phase. For example, the test sequence could include tasks such as, e.g., simulating user interactions, executing predefined scenarios, or injecting artificial load to assess system response under various conditions. Additionally or alternatively, the instructions may include an expected outcome parameter, detailing the anticipated results or performance metrics that the canary components should observe during testing. This parameter can serve as a benchmark against which the actual outcomes can be compared in order to facilitate the detection of deviations or anomalies that may indicate potential issues or regressions in the service. For example, expected outcomes could encompass criteria such as, e.g., response times, error rates, resource utilization, or adherence to service-level agreements.

One or more embodiments may additionally or alternatively incorporate a testing frequency parameter into the instructions, dictating how often the canary components should conduct tests on the first service. This parameter allows organizations to define the frequency of monitoring and validation activities based on their specific requirements and operational needs. For example, critical services may warrant more frequent testing to ensure continuous reliability and performance, while less critical services may undergo periodic or scheduled testing to conserve resources.

One or more embodiments are configured to associate the service with a first customer from a set of customers of the cloud environment. Such embodiments are further configured to publish, by the cloud environment, the service for use by an additional, second customer from the set of customers. One or more embodiments may involve establishing a secure and reliable mechanism for publishing services within the cloud environment. This mechanism ensures that the published service remains protected from unauthorized access and maintains the integrity of its functionalities and data. For example, embodiments may leverage access control policies, authentication mechanisms, and encryption techniques to safeguard the service and regulate access permissions for different users or customer accounts. One or more embodiments may additionally implement a user interface through which customers can discover, browse, and select available services for consumption. This interface can provide customers with visibility into the catalog of published services within the cloud environment. One or more embodiments include approving the service as a first-party service within the cloud environment, where the first-party service is natively compliant with the standards of the cloud environment. One or more embodiments implement this approval process to validate and certify the service's compliance with the established standards, thereby designating it as a first-party service. One or more embodiments initiate the approval process by conducting a comprehensive evaluation of one or more of the service's architecture, functionality, performance, and security aspects. This evaluation may involve, for example, reviewing documentation, conducting tests, and assessing the service against predefined criteria and performance benchmarks specified by the cloud environment. During the approval process, one or more embodiments may verify various aspects of the service. This may include, for example, the service's adherence to security standards, ability to meet performance benchmarks, compatibility with cloud infrastructure components, compliance with regulatory requirements and data governance policies, or integration with security protocols and mechanisms. Furthermore, one or more embodiments may assess the service's scalability, reliability, and fault tolerance capabilities to ensure its suitability for production use within the cloud environment. This may involve, for example, simulating real-world scenarios, conducting load testing, and evaluating performance under different workload conditions.

Upon successful completion of the evaluation process, one or more embodiments issue an approval status to the service, designating it as a first-party service within the cloud environment. This status signifies that the service has met all necessary requirements and standards, thereby qualifying it for native integration and support within the cloud environment. As a first-party service, the approved service may accrue such benefits as, e.g., privileged access to cloud resources, enhanced visibility and monitoring capabilities, or integration with other native services and features offered by the cloud environment.

One or more embodiments include one or more of a predefined network infrastructure or a predefined security protocol. One or more embodiments may incorporate a predefined network infrastructure, which encompasses a set of network resources, configurations, and protocols preconfigured to support the operation and communication requirements of the service and its workers. This infrastructure may include components such as, e.g., virtual networks, subnets, routing tables, load balancers, and firewalls. Similarly, one or more embodiments may integrate a predefined security protocol into the cloud-based infrastructure to enforce security measures and policies aimed at protecting the service, its workers, and the underlying data from unauthorized access, breaches, or malicious activities. This protocol may encompass, e.g., encryption mechanisms, access controls, authentication procedures, intrusion detection systems, and security monitoring tools. One or more embodiments may combine both predefined network infrastructure and predefined security protocols to create an environment that addresses both networking and security requirements.

One or more embodiments may additionally provide flexibility and customization options for adapting the predefined infrastructure to specific use cases, application requirements, and customer preferences. This may involve, for example, parameterization, configuration profiles, or template-based approaches that allow users to tailor the infrastructure settings to suit their needs or preferences.

In an embodiment, once the necessary infrastructure has been provisioned and configured, the system renders the service operational (Operation 1220). The system allows the constituent workers to begin executing the specified cloud-based operations. This operationalization phase involves launching the workers within the allocated compute resources and establishing the requisite network connectivity to allow communication and coordination between them. One or more embodiments may monitor the health and performance of the service in real-time, employing automated alerting and error-handling mechanisms to detect and address any issues that arise during operation. One or more embodiments may implement load balancing and auto-scaling techniques to dynamically adjust the resource allocation and scale the service in response to changing workload demands. One or more embodiments may integrate with first- or third-party logging and monitoring tools to collect and analyze operational data, facilitating performance optimization and continuous improvement of the service.

### 5. Example Embodiment: Workers and Worker Types

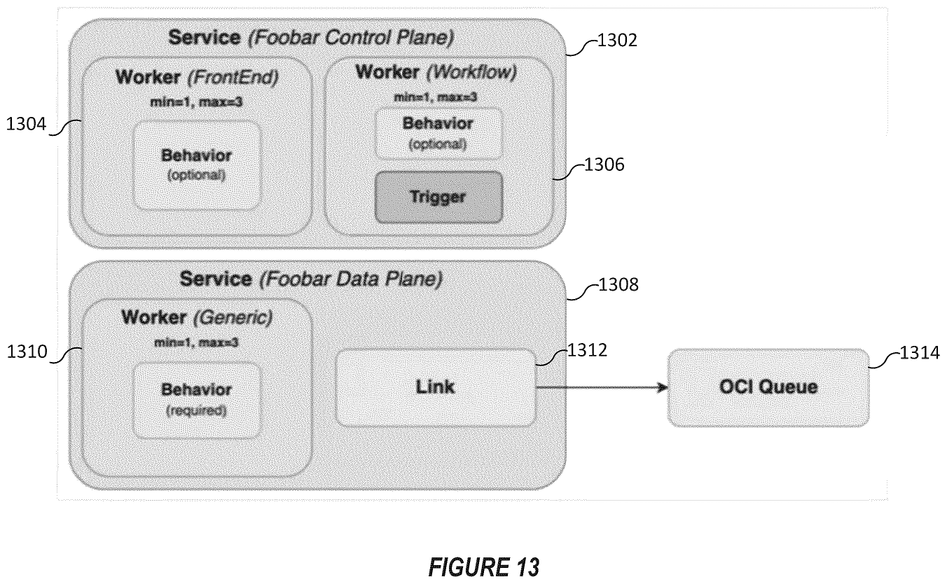

FIG. 13 illustrates an example for configuring worker interactions within a service and between services in a cloud environment, in accordance with an embodiment. The system comprises a service 1302, such as a control plane 1302 for a service named Foobar and one or more associated workers within it, and a data plane 1308 for the service and one or more associated workers within it. The workers can be of different types, including frontend workers 1304 designed to interact with users or external systems, and workflow workers 1306 designed to perform tasks within a service's workflow. Workers can optionally be assigned behaviors or functionalities that define their capabilities, such as the ability to call other services or respond to incoming requests.

The system also facilitates communication between workers and services. A trigger within a workflow worker 1306 is depicted which can be used, for example, to wake up an asynchronous worker, while a link 1312 can facilitate communication between workers and other services, such as the cloud service's queue 1314 to facilitate communication between a generic (i.e., custom-defined by a user) worker 1310. This demonstrates the system's flexibility in supporting various communication mechanisms between workers and services within a cloud environment.

### 5. Example Embodiment for a Notifications Service

A detailed example is described below for purposes of clarity. Components and/or operations described below should be understood as one specific example which may not be applicable to certain embodiments. Accordingly, components and/or operations described below should not be construed as limiting the scope of any of the claims.

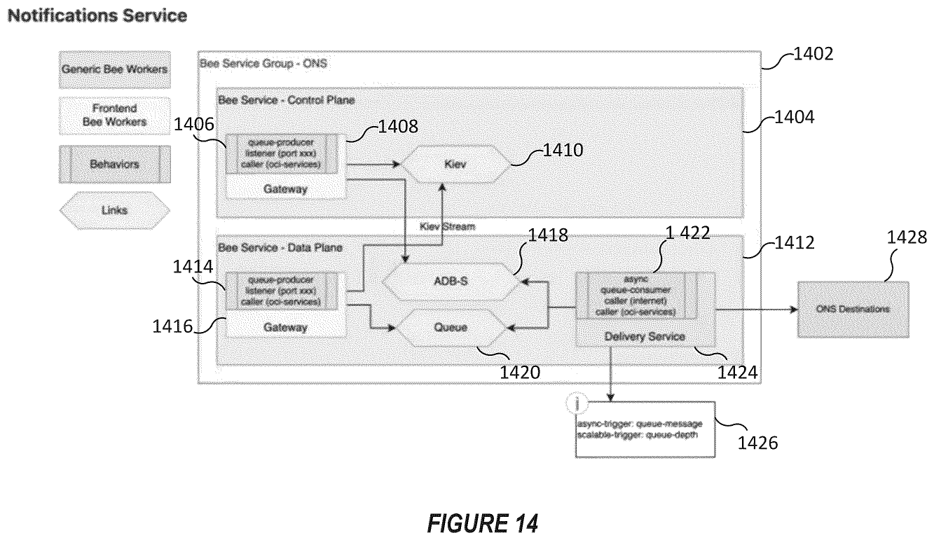

FIG. 14 of the invention illustrates an example system and method for implementing a cloud-based notifications service, in accordance with an embodiment. This service architecture facilitates sending notifications to users or applications through various delivery channels.

The system includes a service group 1402 which contains a control plane 1404 for a service, and a data plane 1412 for the service. The control plane 1404 includes a frontend worker 1408 that functions as a gateway worker, with a set of functionalities 1408 for queue-producer, listener on port xxx, and caller of cloud services. Users or applications can interact with this frontend to initiate notification requests. This central control unit coordinates and manages the overall notification delivery process.

The workers are responsible for executing the core functionalities of the service. These workers leverage predefined behaviors to perform various tasks related to notification delivery. The specific behaviors assigned to a worker determine its role in the process. For instance, a worker might be assigned a behavior that allows it to send email notifications, while another worker might have a behavior for SMS message delivery.

Links 1410, 1418, and 1420 facilitate communication between workers and other components within the system. A queue-producer link 1410 connects workers to a queueing mechanism. This allows workers to add notification messages to a queue for further processing. Within the data plane 1412, another gateway worker 1416 includes similar functionality 1414 to the previous gateway worker. A link ADB-S 1418 functions as a data storage component within the system. This database stores notification data or configuration information required for the delivery process. Another link, the queue 1420, connects workers to a delivery service. This allows workers to interact with the appropriate service (e.g., email provider, SMS gateway) to ultimately deliver the notifications to their designated destinations, such as Destinations 1424).

The system also incorporates triggers 1426 to automate actions based on specific events. An async-trigger is activated when a new message is added to the queue from the queue-producer link. This can trigger a worker to process the message and potentially send a notification. Additionally, a scalable-trigger monitors the queue depth. This trigger, based on the volume of messages in the queue, can be used to dynamically scale resources. For example, the system could automatically spin up additional worker instances when the queue size increases.

### 6. Example Embodiment for a Connector Hub Service

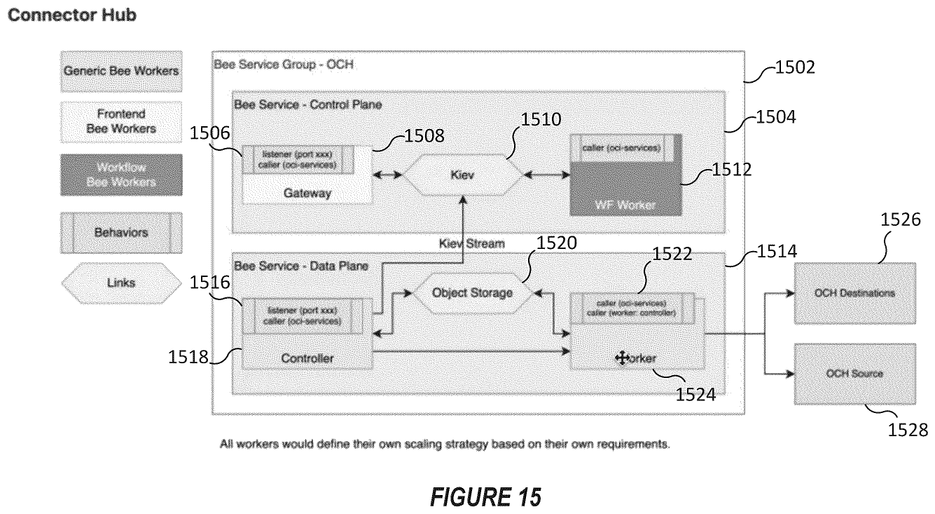

FIG. 15 illustrates an example system and method for implementing a cloud-based connector hub service, in accordance with an embodiment. This service allows users to automate data movement between diverse sources and destinations within a cloud environment.

The system includes a service group 1502, which includes a control plane 1504 and data plane 1514. The control plane 1504 acts as the central control unit for the connector hub service. This control plane coordinates and manages the overall data movement process based on user instructions. A gateway worker 1506 serves as an initial interaction point for users. Users can interact with this frontend to initiate data movement requests, specifying the source and destination of the data. A link 1510 connects the gateway worker 1508 with a workflow worker 1512. The type of worker assigned to a task depends on the nature of the data transfer. Workflow workers typically handle the core logic for moving data, facilitating the transfer steps between source and destination. Gateway workers specialize in interacting with external data sources or destinations. These workers can establish connections and handle data exchange protocols specific to the external systems involved. Links 1510 and 1520 facilitate communication between workers and other components within the system.

Within the data plane 1514, a controller worker 1518 includes listener and caller functionalities 1516. An object storage system (1520) serves as a temporary data storage repository during the transfer process. Data can be staged in object storage before being written to the final destination. A generic worker 1524 passes messages on to a data source 1528 and data destinations 1526. Both source and destination references point to cloud resources, indicating that the connector hub can integrate with various data storage options available within the cloud environment. This flexibility allows users to move data between cloud services, user-managed storage in the cloud, or even external data sources accessible through supported protocols.

The connector hub service is facilitated by the system enabling different worker specializations, cloud services, and communication mechanisms to automate and manage data movement between diverse sources and destinations within a cloud environment. This system offers a versatile solution for users to streamline data transfer workflows and facilitate data exchange within their cloud infrastructure.

### 7. Example Embodiment: Configuring a Canary Component for Testing a Service

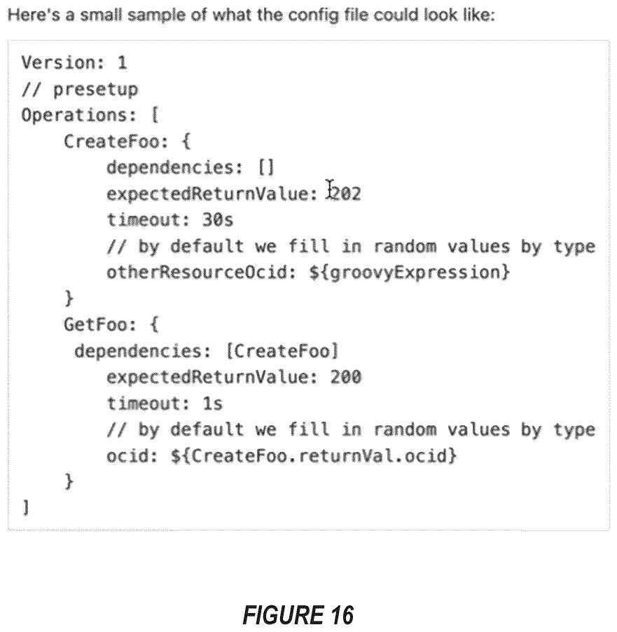

FIG. 16 illustrates an example of a code snippet used for configuring a canary component to test a service within a cloud environment, in accordance with an embodiment. The code snippet showcases how users can define canary testing criteria within a service. The snippet specifies the version (1) of the configuration schema, referring to a standardized format for defining canary test configurations.

The core functionality is defined within the ‘Operations’ section. Here, users specify the operations that the canary component will execute to test the service. The example shows two operations: ‘CreateFoo’ and ‘GetFoo’. These operations correspond to service functionalities exposed through APIs. For instance, ‘CreateFoo’ represents an API call to create a resource named ‘Foo’, while ‘GetFoo’ represents an API call to retrieve a ‘Foo’ resource. Notably, the code snippet itself doesn't contain the implementation details for these operations.

The system facilitates the management of dependencies between operations based on the user's instructions within the code. In the example, ‘Dependencies’ specify that the ‘GetFoo’ operation depends on the successful execution of ‘CreateFoo’. This ensures that ‘GetFoo’ is only invoked after a ‘Foo’ resource has been created by ‘CreateFoo’, establishing a logical sequence for the canary testing process.

The ‘ExpectedReturn Value’ section allows users to define the anticipated outcome for specific operations. The code snippet shows that ‘CreateFoo’ is expected to return an error code of 1202. This illustrates that the canary test is designed to evaluate how the service behaves under error conditions, such as handling situations where resource creation fails with a specific error code.

Finally, ‘Timeout’ values are defined for each operation. These timeouts specify the maximum permissible execution time for an operation before the canary component marks it as a failure. For instance, ‘CreateFoo’ has a timeout of 30 seconds, while ‘GetFoo’ has a 1-second timeout. This allows the canary component to identify situations where operations hang or take excessively long to complete.

In essence, the figure illustrates how the systems and methods facilitate canary testing for cloud services. By providing a configuration schema, the system allows users to define testing criteria through operations, dependencies, expected return values, and timeouts. The system then automates the execution of these tests, generating alarms or metrics based on the test results.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
receiving, by a cloud environment, instructions that define a first service to be executed in the cloud environment, the first service comprising a plurality of workers configured to collectively perform one or more cloud-based operations;
receiving, by the cloud environment, instructions that define a first worker in the plurality of workers, the first worker being configured to perform a subset of the one or more cloud-based operations;
based on the instructions that define the first worker: determining, by the cloud environment, that the first worker is of a particular type of a plurality of types, the plurality of types being associated with respective predefined sets of cloud-based functionality;
responsive to determining that the first worker is of the particular type:
applying, by the cloud environment, a corresponding predefined set of cloud-based functionality to the first worker; and
instantiating, by the cloud environment, predefined cloud-based infrastructure that supports the corresponding predefined set of cloud-based functionality.

2. The one or more non-transitory computer-readable media of claim 1, wherein the predefined cloud-based infrastructure is configured to facilitate communication between the first worker and one or more of: a second worker in the plurality of workers; a second service; or the Internet.

3. The one or more non-transitory computer-readable media of claim 1, wherein:
the instructions that define the first worker indicate that the first worker is asynchronous; and
the predefined cloud-based infrastructure is configured to activate the first worker responsive to detecting one or more triggering events.

4. The one or more non-transitory computer-readable media of claim 1, wherein the predefined cloud-based infrastructure comprises one or more canary components configured to test whether the first service is operational.

5. The one or more non-transitory computer-readable media of claim 4, wherein the instructions that define the first worker comprise a parameter that defines, for the one or more canary components, one or more of: a test sequence; an expected outcome; or a testing frequency.

6. The one or more non-transitory computer-readable media of claim 1, wherein the first service is associated with a first customer in a plurality of customers of the cloud environment, the operations further comprising:
publishing, by the cloud environment, the first service for use by a second customer in the plurality of customers.

7. The one or more non-transitory computer-readable media of claim 1, wherein the predefined cloud-based infrastructure comprises one or more of predefined network infrastructure or a predefined security protocol.

8. A method comprising:
receiving, by a cloud environment, instructions that define a first service to be executed in the cloud environment, the first service comprising a plurality of workers configured to collectively perform one or more cloud-based operations;
receiving, by the cloud environment, instructions that define a first worker in the plurality of workers, the first worker being configured to perform a subset of the one or more cloud-based operations;
based on the instructions that define the first worker: determining, by the cloud environment, that the first worker is of a particular type of a plurality of types, the plurality of types being associated with respective predefined sets of cloud-based functionality;
responsive to determining that the first worker is of the particular type:
applying, by the cloud environment, a corresponding predefined set of cloud-based functionality to the first worker; and
instantiating, by the cloud environment, predefined cloud-based infrastructure that supports the corresponding predefined set of cloud-based functionality;
wherein the method is performed by at least one device including a hardware processor.

9. The method of claim 8, wherein the predefined cloud-based infrastructure is configured to facilitate communication between the first worker and one or more of: a second worker in the plurality of workers; a second service; or the Internet.

10. The method of claim 8, wherein:
the instructions that define the first worker indicate that the first worker is asynchronous; and
the predefined cloud-based infrastructure is configured to activate the first worker responsive to detecting one or more triggering events.

11. The method of claim 8, wherein the predefined cloud-based infrastructure comprises one or more canary components configured to test whether the first service is operational.

12. The method of claim 11, wherein the instructions that define the first worker comprise a parameter that defines, for the one or more canary components, one or more of: a test sequence; an expected outcome; or a testing frequency.

13. The method of claim 8, wherein the first service is associated with a first customer in a plurality of customers of the cloud environment, the operations further comprising:
publishing, by the cloud environment, the first service for use by a second customer in the plurality of customers.

14. The method of claim 8, wherein the predefined cloud-based infrastructure comprises one or more of predefined network infrastructure or a predefined security protocol.

15. A system comprising:
one or more hardware processors;
one or more non-transitory computer-readable media; and
program instructions stored on the one or more non-transitory computer readable media which, when executed by the one or more hardware processors, cause the system to perform operations comprising:
receiving, by a cloud environment, instructions that define a first service to be executed in the cloud environment, the first service comprising a plurality of workers configured to collectively perform one or more cloud-based operations;
receiving, by the cloud environment, instructions that define a first worker in the plurality of workers, the first worker being configured to perform a subset of the one or more cloud-based operations;
based on the instructions that define the first worker: determining, by the cloud environment, that the first worker is of a particular type of a plurality of types, the plurality of types being associated with respective predefined sets of cloud-based functionality;
responsive to determining that the first worker is of the particular type:
applying, by the cloud environment, a corresponding predefined set of cloud-based functionality to the first worker; and
instantiating, by the cloud environment, predefined cloud-based infrastructure that supports the corresponding predefined set of cloud-based functionality.

16. The system of claim 15, wherein the predefined cloud-based infrastructure is configured to facilitate communication between the first worker and one or more of: a second worker in the plurality of workers; a second service; or the Internet.

17. The system of claim 15, wherein:
the instructions that define the first worker indicate that the first worker is asynchronous; and
the predefined cloud-based infrastructure is configured to activate the first worker responsive to detecting one or more triggering events.

18. The system of claim 15, wherein the predefined cloud-based infrastructure comprises one or more canary components configured to test whether the first service is operational.

19. The system of claim 15, wherein the first service is associated with a first customer in a plurality of customers of the cloud environment, the operations further comprising:
publishing, by the cloud environment, the first service for use by a second customer in the plurality of customers.

20. The system of claim 15, wherein the predefined cloud-based infrastructure comprises one or more of predefined network infrastructure or a predefined security protocol.
